(19) United States
(12) Patent Application Publication
(10) Pub. No.: US 2013/0226636 A1
(43) Pub. Date: Aug. 29, 2013

(54) AUTOMATED MAPPING OF PRODUCT ADJACENCY GROUPS WITH TRANSITION SUMMARY REPORTING

(71) Applicants: Pat Hathaway, Minneapolis, MN (US); Derek Johnson, Apple Valley, MN (US); Stacey Faulkenberg, Minneapolis, MN (US)

(72) Inventors: Pat Hathaway, Minneapolis, MN (US); Derek Johnson, Apple Valley, MN (US); Stacey Faulkenberg, Minneapolis, MN (US)

(73) Assignee: TARGET BRANDS, INC., Minneapolis, MN (US)

(21) Appl. No.: 13/452,599

(22) Filed: Apr. 20, 2012

Related U.S. Application Data
(60) Provisional application No. 61/604,324, filed on Feb. 28, 2012.

(51) Int. Cl. G06Q 10/06

(52) U.S. Cl. 705/7.11

(57) ABSTRACT

A system for generating a product subgroup map for a product adjacency group with transition summary reporting is disclosed. In one example, a user interface is configured for presenting data on product subgroups and receiving user inputs for user-editable mapping criteria for mapping the product subgroups. The user interface has user-selectable options for editing and assigning priority values to the mapping criteria of the product subgroups. The system generates a combined set of mapping criteria for the user-selected product subgroups based on the user-edited mapping criteria and non-user-editable mapping criteria. The system generates a product subgroup map based on the combined set of mapping criteria and a set of physical store layout data for at least one store, and provides a graphical output of the product subgroup map. The system generates a report for the product subgroup map for the product adjacency group.

### TECHNICAL FIELD

This disclosure relates to merchandising, and more particularly, to software for automating aspects of organizing product placement in retail stores.

### BACKGROUND

Modern large retail stores provide a great variety of products, such as tens of thousands of different products at one time. Planning the physical arrangement of all of these products in a store, which may be referred to as “merchandise presentation planning”, may be a complex and arduous task. How all of these products are physically arranged in the store may make a great difference in whether customers can easily find what they're looking for, how they make shopping decisions, what they end up purchasing, how they enjoy their overall shopping experience, and how their shopping habits are shaped. How all of the products are physically arranged in the store may therefore also make a great difference in margins and profits.

Besides the large number of products by itself, many additional factors further complicate the process of merchandise presentation planning A retail enterprise may have many store locations with different sizes, dimensions, and features, so that a merchandise presentation plan generated for one store's layout may be inapplicable to a different store, which may have very different size, layout, or architectural constraints. Additionally, product vendors typically often update or retire products and introduce new products. The retail enterprise may regularly analyze sales patterns and market shifts and decide to cancel product lines, decrease or increase the amount of inventory and shelf space to devote to different product lines, or begin carrying new product lines. The retail enterprise may also shift its product mix at different times of year, including to carry summer clothing and winter clothing at the appropriate times, to carry other seasonal-related products at the appropriate times such as shovels in the winter and sunscreen in the summer, and to carry holiday-related items leading up to various holidays. The retail enterprise may also cater to different regionally varying market demands with products that are particularly in demand in certain geographical regions. These factors all contribute further complexity to the process of merchandise presentation planning across retail stores for a retail enterprise.

### SUMMARY

In general, this disclosure is directed to methods, computing systems, and software for automating the process of merchandise presentation planning, including across numerous stores in a retail enterprise. An automated merchandise presentation planning system uses detailed data on products and product category groups and subgroups; merchandise planning rules, strategies, and goals; and the physical layout of the stores and the gondolas, shelves, and other merchandise presentation structures throughout each of the stores. The automated merchandise presentation planning system provides a user interface for a merchandise presentation planning process that the user can enter or modify a merchandise presentation plan, including by entering different priority levels to different merchandise planning rules, strategies, and goals. The automated merchandise presentation planning system then automatically generates new merchandise presentation maps that balance the various merchandise planning rules, strategies, and goals, both permanent and those entered by the user, within the constraints of the physical layout of the stores, in accordance with the different priority levels indicated, again both permanent priority levels and those entered by the user. The automated merchandise presentation planning system may perform this process for each of a number of different store layouts for any number of stores selected by the user. The automated merchandise presentation planning system may thereby implement the goals of the retail enterprise and its users rapidly and consistently, while automating a great deal of the process.

In one example, a method for generating a product subgroup map with a computing system includes providing a user interface configured for presenting data on product subgroups for a product adjacency group and receiving user inputs associated with user-editable mapping criteria for mapping the product subgroups in the product adjacency group. The method further includes configuring the user interface with indications of the product subgroups that are user-selectable for editing the user-editable mapping criteria of the product subgroups. The method further includes receiving one or more user inputs indicating one or more user-selected product subgroups from among the product subgroups. The method further includes configuring the user interface with user-selectable options for editing the user-editable mapping criteria of the product subgroups, and for assigning priority values to the user-editable mapping criteria. The method further includes receiving one or more user inputs for each of the user-editable mapping criteria. The method further includes generating a combined set of mapping criteria for the one or more user-selected product subgroups based on the one or more user inputs for each of the user-editable mapping criteria and one or more non-user-editable mapping criteria stored in a mapping rules data store, wherein the one or more non-user-editable mapping criteria comprise a persistence criterion that places a high priority on persisting product subgroup mapping positions from a previous product subgroup map for the product subgroup. The method further includes generating a product subgroup map for the one or more user-selected product subgroups based on the combined set of mapping criteria for the one or more user-selected product subgroups and a set of physical store layout data for at least one store. The method further includes providing a graphical output of the product subgroup map for the product adjacency group. The method further includes generating a report for the product subgroup map for the product adjacency group.

Another example of this disclosure is directed to a computing system that includes one or more processors, one or more computer-readable tangible storage devices, a display device, a user input device, and program instructions stored on at least one of the one or more computer-readable tangible storage devices. The computing system includes program instructions to provide a user interface configured for presenting data on product subgroups for a product adjacency group and receiving user inputs associated with user-editable mapping criteria for mapping the product subgroups in the product adjacency group. The computing system further includes program instructions to configure the user interface with indications of the product subgroups that are user-selectable for editing the user-editable mapping criteria of the product subgroups. The computing system further includes program instructions to receive one or more user inputs indicating one or more user-selected product subgroups from among the product subgroups. The computing system further includes program instructions to configure the user interface with user-selectable options for editing the user-editable mapping criteria of the product subgroups, and for assigning priority values to the user-editable mapping criteria. The computing system further includes program instructions to receive one or more user inputs for each of the user-editable mapping criteria. The computing system further includes program instructions to generate a combined set of mapping criteria for the one or more user-selected product subgroups based on the one or more user inputs for each of the user-editable mapping criteria and one or more non-user-editable mapping criteria stored in a mapping rules data store. The computing system further includes program instructions to generate a product subgroup map for the one or more user-selected product subgroups based on the combined set of mapping criteria for the one or more user-selected product subgroups and a set of physical store layout data for at least one store. The computing system further includes program instructions to provide a graphical output of the product subgroup map for the product adjacency group. The computing system further includes program instructions to generate a report for the product subgroup map for the product adjacency group.

Another example of this disclosure is directed to a computer program product that includes one or more computer-readable tangible storage devices, and program instructions stored on at least one of the one or more computer-readable tangible storage devices. The computer program product includes program instructions to provide a user interface configured for presenting data on product subgroups for a product adjacency group and receiving user inputs associated with user-editable mapping criteria for mapping the product subgroups in the product adjacency group. The computer program product further includes program instructions to configure the user interface with indications of the product subgroups that are user-selectable for editing the user-editable mapping criteria of the product subgroups. The computer program product further includes program instructions to receive one or more user inputs indicating one or more user-selected product subgroups from among the product subgroups. The computer program product further includes program instructions to configure the user interface with user-selectable options for editing the user-editable mapping criteria of the product subgroups, and for assigning priority values to the user-editable mapping criteria. The computer program product further includes program instructions to receive one or more user inputs for each of the user-editable mapping criteria. The computer program product further includes program instructions to generate a combined set of mapping criteria for the one or more user-selected product subgroups based on the one or more user inputs for each of the user-editable mapping criteria and one or more non-user-editable mapping criteria stored in a mapping rules data store. The computer program product further includes program instructions to generate a product subgroup map for the one or more user-selected product subgroups based on the combined set of mapping criteria for the one or more user-selected product subgroups and a set of physical store layout data for at least one store. The computer program product further includes program instructions to provide a graphical output of the product subgroup map for the product adjacency group. The computer program product further includes program instructions to generate a report for the product subgroup map and previous product subgroup maps for the product adjacency group.

The details of one or more embodiments of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example of an adjacency mapping system that implements techniques of this disclosure.

FIG. 2 is a block diagram illustrating an example of the adjacency mapping system of FIG. 1 within the context of an extended enterprise computing system.

FIG. 3 is a block diagram illustrating an example implementation of a server device that implements an adjacency mapping system in accordance with aspects of this disclosure.

FIG. 4 is a block diagram illustrating an example implementation of a client computing device that implements a user interface for an adjacency mapping system in accordance with aspects of this disclosure.

FIG. 5 is a graphical output representing physical store layout data for a store, that may be provided in a user interface for an adjacency mapping system in accordance with aspects of this disclosure.

FIG. 6 is a graphical output representing physical store layout data for a portion of a store, that may be provided in a user interface for an adjacency mapping system in accordance with aspects of this disclosure.

FIG. 7 is a graphical output of a product subgroup map for a product adjacency group within the store layout of a store, that may be provided in a user interface for a visual merchandising tool (VMT) module of an adjacency mapping system in accordance with aspects of this disclosure.

FIG. 8 is a graphical output of an aspect of a user interface for single subgroup mapping with a transition center (TC) module of an adjacency mapping system in accordance with aspects of this disclosure.

FIG. 9 is a graphical output of an aspect of a user interface for a subgroup mapping summary with a transition center (TC) module of an adjacency mapping system in accordance with aspects of this disclosure.

FIG. 10 is a graphical output of an aspect of a user interface for store assignment add and remove with a transition center (TC) module of an adjacency mapping system in accordance with aspects of this disclosure.

FIG. 11 is a graphical output of an aspect of a user interface for store assignment with a transition center (TC) module of an adjacency mapping system in accordance with aspects of this disclosure.

FIG. 12 is a graphical output of an aspect of a user interface for a shops and sub-shops feature in a transition center (TC) module of an adjacency mapping system in accordance with aspects of this disclosure.

FIG. 13 is a graphical output of an aspect of a user interface for a shops and sub-shops feature in a transition center (TC) module of an adjacency mapping system in accordance with aspects of this disclosure.

FIG. 14 is a graphical output of an aspect of a user interface for a merchandising grid (MG) module of an adjacency mapping system in accordance with aspects of this disclosure.

FIG. 15 is a graphical output of an aspect of a user interface for a subgroup assignment function of a merchandising grid (MG) module of an adjacency mapping system in accordance with aspects of this disclosure.

FIG. 16 is a graphical output of an aspect of a user interface for a store assignment function of a merchandising grid (MG) module of an adjacency mapping system in accordance with aspects of this disclosure.

FIG. 17 is a graphical output of an aspect of a user interface for a strategy assignment function of a merchandising grid (MG) module of an adjacency mapping system in accordance with aspects of this disclosure.

FIG. 18 is a graphical output of an aspect of a user interface for a strategy defining function of a merchandising grid (MG) module of an adjacency mapping system in accordance with aspects of this disclosure.

FIG. 19 is a graphical output of an aspect of a user interface for a subgroup footage defining function of a merchandising grid (MG) module of an adjacency mapping system in accordance with aspects of this disclosure.

FIG. 20 is a graphical output of an aspect of a user interface for an action sequence defining function of a merchandising grid (MG) module of an adjacency mapping system in accordance with aspects of this disclosure.

FIG. 21 is a graphical output of an aspect of a user interface for a flow sequence defining function of a merchandising grid (MG) module of an adjacency mapping system in accordance with aspects of this disclosure.

FIG. 22 is a graphical output of an aspect of a user interface for a strategy priority assignment function of a merchandising grid (MG) module of an adjacency mapping system in accordance with aspects of this disclosure.

FIG. 23 is a graphical output of an aspect of a user interface for activating a rules maintenance application (RMA) module of an adjacency mapping system in accordance with aspects of this disclosure.

FIG. 24 is a graphical output of an aspect of a user interface for a rule set creation function in a rules maintenance application (RMA) module of an adjacency mapping system in accordance with aspects of this disclosure.

FIG. 25 is a graphical output of an aspect of a user interface for a strategy selection function of a rules maintenance application (RMA) module of an adjacency mapping system in accordance with aspects of this disclosure.

FIG. 26 is a graphical output of an aspect of a user interface for a rule creation function in a rules maintenance application (RMA) module of an adjacency mapping system in accordance with aspects of this disclosure.

FIG. 27 is a graphical output of an aspect of a user interface for creating an automated store merchandising (ASM) run in an ASM module of an adjacency mapping system in accordance with aspects of this disclosure.

FIG. 28 is a graphical output of an aspect of a user interface for a store selection function in an automated store merchandising (ASM) module of an adjacency mapping system in accordance with aspects of this disclosure.

FIG. 29 is a graphical output of aspects of persistence logic for an automated store merchandising (ASM) module of an adjacency mapping system in accordance with aspects of this disclosure.

FIG. 30 is a graphical output of an aspect of a user interface for automated store merchandising (ASM) runs in an ASM module of an adjacency mapping system in accordance with aspects of this disclosure.

FIG. 31 is a graphical output of an aspect of a user interface for a reporting feature for an automated store merchandising (ASM) module of an adjacency mapping system in accordance with aspects of this disclosure.

FIG. 32 is a graphical output of an aspect of a user interface for a transition reporting feature for an adjacency mapping system in accordance with aspects of this disclosure.

FIG. 33 is a graphical output of an aspect of a user interface for a reporting feature for an automated store merchandising (ASM) module of an adjacency mapping system in accordance with aspects of this disclosure.

FIG. 34 is a graphical output of an aspect of a user interface for a store status function of a transition center (TC) module of an adjacency mapping system in accordance with aspects of this disclosure.

FIG. 35 is a graphical output of an aspect of a user interface for a search function with a visual merchandising tool (VMT) module of an adjacency mapping system in accordance with aspects of this disclosure.

FIG. 36 is a graphical output of an aspect of a user interface for search results with a visual merchandising tool (VMT) module of an adjacency mapping system in accordance with aspects of this disclosure.

FIG. 37 is a graphical output of a product subgroup map for an automatically merchandised product adjacency group within the store layout of a store, that may be provided in a user interface for a visual merchandising tool (VMT) module of an adjacency mapping system in accordance with aspects of this disclosure.

FIG. 38 is a flowchart illustrating an example method of operation of an adjacency mapping system of this disclosure.

### DETAILED DESCRIPTION

As used throughout this disclosure, headings are included to improve the clarity of the disclosure and are not necessarily used to define separate embodiments. In some examples, features of various embodiments may be combined and/or used from among contents discussed under multiple headings in accordance with aspects of the present disclosure.

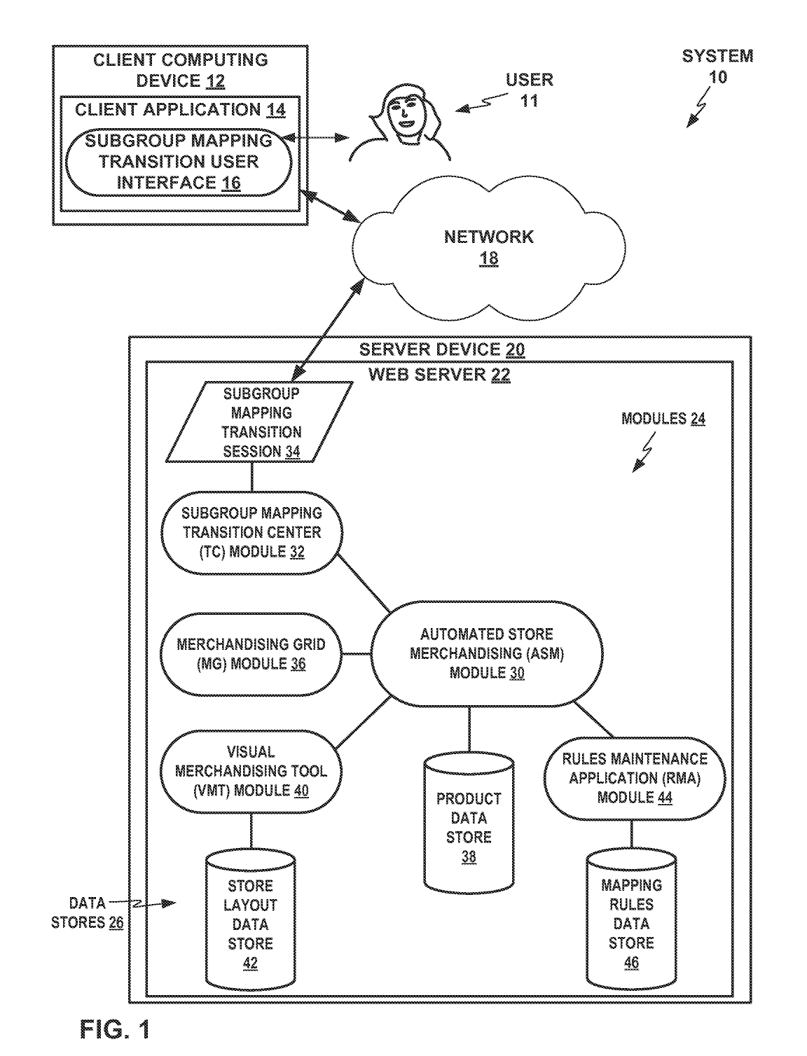

FIG. 1: System Overview

FIG. 1 is a block diagram illustrating an example of an adjacency mapping system 10 that implements various techniques of this disclosure, including for automated mapping of product subgroups in adjacency groups. As shown in FIG. 1, adjacency mapping system 10 includes client computing device 12 and server device 20 connected through network 18, so that a user 11 is enabled to use client computing device 12 to interact with services provided by server device 20, such as from a web application. Client application 14 runs on client running computing device 12 and provides a subgroup mapping transition user interface 16, which provides information to user 11 and receives user inputs from user 11. Server device 20 hosts a web server 22 with one or more web applications running on it, which may include and/or have access to various modules 24 and data stores 26.

Modules 24 include an automated store merchandising (ASM) module 30, a subgroup mapping transition center (TC) module 32, a merchandising grid (MG) module 36, a visual merchandising tool (VMT) module 40, and a rules maintenance application (RMA) module 44, in this example. Modules 24 may be or include separate applications, libraries, or objects, or software modules of a single web application. Modules 24 may interact with each other and with data stores 26. TC module 32 may interact with and give user 11 operative access to each of ASM module 30, MG module 36, VMT module 40, and RMA module 44, in the example of FIG. 1. In general, adjacency mapping system 10 is configured to enable user 11 to gain information and enter inputs about product adjacency groups, and to generate product subgroup maps for product adjacency groups in accordance with techniques disclosed herein. Various aspects of adjacency mapping system 10 and the functions that each of TC module 32 may interact with and give user 11 operative access to each of ASM module 30, MG module 36, VMT module 40, and RMA module 44 perform as part of adjacency mapping system 10 are further detailed below.

Data stores 26 include product data store 38, store layout data store 42, and mapping rules data store 44 in the example of FIG. 1. ASM module 30 may access product data store 38, which may be configured to store information about a number of products, which may include a wide variety of data about potentially thousands or tens or hundreds of thousands of different products at one time. VMT module 40 may access store layout data store 42, which may be configured to store detailed data on physical store layout, including architectural plans, and locations and dimensions of walls, shelves, racks, and other merchandising fixtures. RMA module may access mapping rules data store 46, which includes data on product categorization such as into one or more of departments, adjacency groups, shops, sub-shops, and product subgroups, and rules and criteria for product merchandising such as for product subgroup mapping within a product adjacency group.

Product data store 38, store layout data store 42, and mapping rules data store 44 (collectively, “data stores 26”) may each include a standard or proprietary database or other data storage and retrieval mechanism. Data stores 26 may each be implemented in software, hardware, and combinations of both. For example, data stores 26 may each include proprietary database software stored on one of a variety of storage mediums on a data storage server connected to server device 20 and configured to send data to and collect data from server device 20. Storage mediums included in or employed in cooperation with data stores 26 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

In various examples, server device 20 and client computing device 12 may be communicatively connected via a network 18. The network 18 may include one or more terrestrial and/or satellite networks interconnected to provide a means of communicatively connecting server device 20 and client computing device 12. For example, the network 18 may include an enterprise intranet, a private or public local area network, or a wide area network, including, for example, the Internet. The network 18 may include both wired and wireless communications according to one or more standards and/or via one or more transport mediums. For example, the network may include wireless communications according to one of the 802.11 or Bluetooth specification sets, or another standard or proprietary wireless communication protocol. The network 18 may also include communications over a terrestrial cellular network, including, e.g. a GSM (Global System for Mobile Communications), CDMA (Code Division Multiple Access), EDGE (Enhanced Data for Global Evolution) network. Data transmitted over the network 18, e.g., between server device 20 and client computing device 12, may be formatted in accordance with a variety of different communications protocols. For example, all or a portion of the network may be a packet-based, Internet Protocol (IP) network that communicates data between server device 20 and client computing device 12 in Transmission Control Protocol/Internet Protocol (TCP/IP) packets, over, e.g., Ethernet via Category 5 cables.

Server device 20 and client computing device 12 may include any number of different computing devices. For example, server device 20 and client computing device 12 may include networked computing devices that include network communication elements configured to send and receive data via a network. Examples of client device 12 include desktop computers, tablet computers, laptop computers, cellular phones, or other portable, non-portable, or mobile devices. While the example of FIG. 1 illustratively depicts one server device 20 and one client computing device 12, other examples may include a number of co-located or distributed computing devices configured in accordance with techniques of this disclosure.

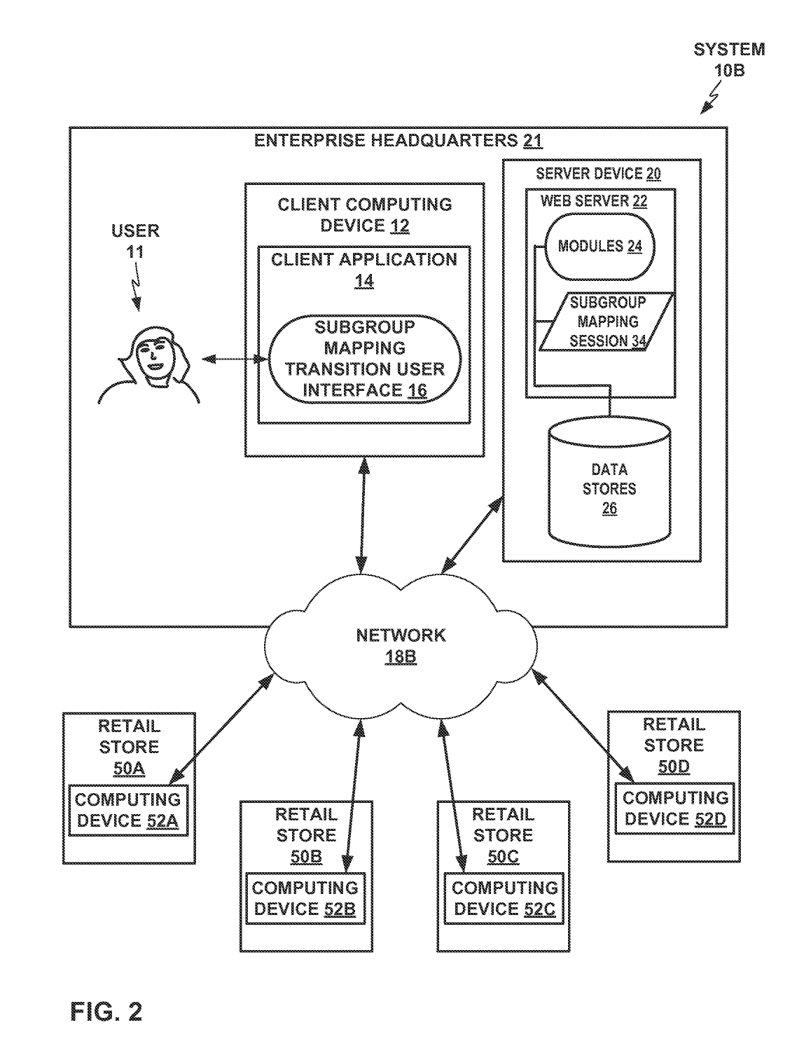

FIG. 2: Overview of Extended System

FIG. 2 is a block diagram illustrating an example of the adjacency mapping system 10 of FIG. 1 within the context of an extended enterprise computing system 10B. User 11, client computing device 12, and server device 20 may be associated with an enterprise headquarters 21 or management of a retail enterprise. User 11 may use transition user interface 16 provided by client application 14 running on computing system 10B as part of a merchandising management function at or associated with enterprise headquarters 21. Modules 24 and data stores 26 may be hosted by servers belonging to, located at, associated with, or in cooperation with enterprise headquarters 21, and which may illustratively include server device 20. Server device 20 running modules 24 with access to data stores 26 may host a product subgroup mapping transition center session 34 as part of a web application that user 11 interacts with by way of transition center user interface 16 running on client computing device 12, in this example.

Network 18 may include an enterprise intranet and/or the Internet, and may connect server device 20 not only to client computing device 12 but also to computing devices 52A, 52B, 52C, and 52D (“computing devices 52A-52D”) at illustrative retail stores 50A, 50B, 50C, 50D (“retail stores 50A-50D”) that are part of the retail enterprise. Server device 20 may thereby communicate data rapidly to computing devices 52A-D at retail stores 50A-D, including subgroup mapping data generated by server device 20, such as graphical outputs of product subgroup maps for product adjacency groups.

User 11 may therefore interact with transition user interface 16 to use adjacency mapping system 10 to generate product subgroup maps for product adjacency groups, and then send the product subgroup maps from enterprise headquarters 21 to retail stores 50A-D. While four retail stores are illustratively depicted in FIG. 2, enterprise computing system 10B may include any number of retail stores, from one or two to hundreds or thousands or more.

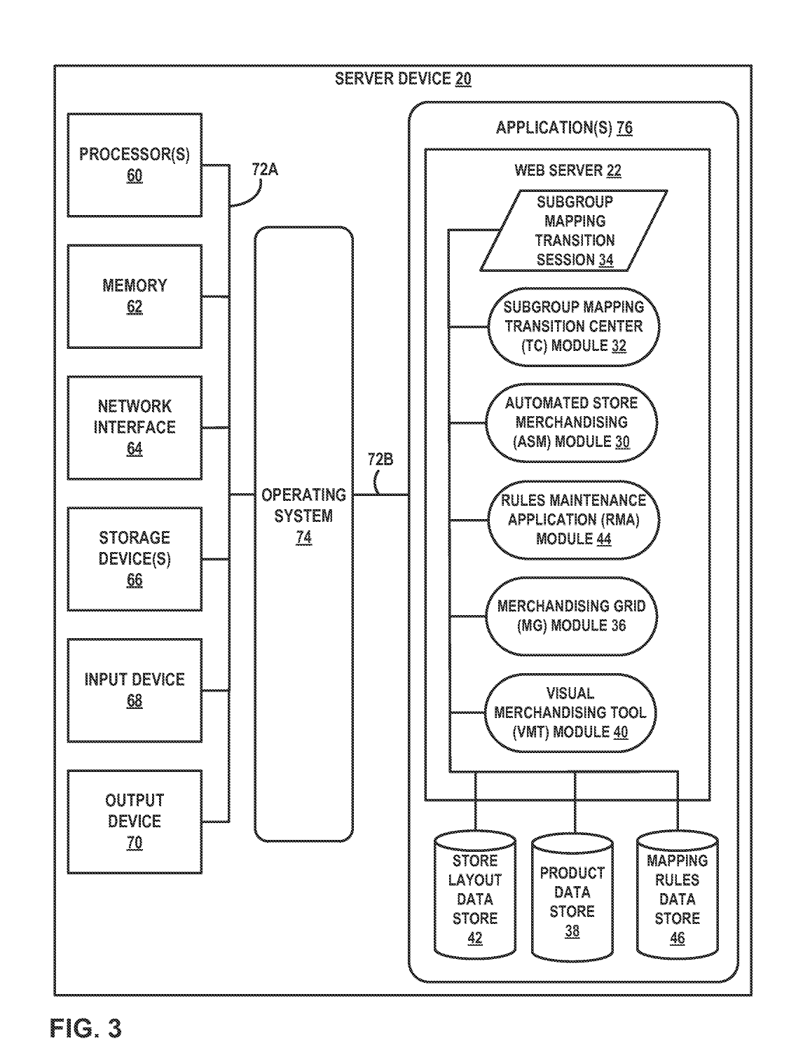

FIG. 3: Example Server Device

FIG. 3 is a block diagram illustrating further details of an example of server device 20 shown in FIGS. 1 and 2, and to provide details of how server device 20 may provide part of the basis for the functioning of adjacency mapping system 10. FIG. 3 illustrates only one particular example of server device 20, and many other example embodiments of server device 20 may be used in other instances. Additionally, client computing device 12 shown in FIG. 1 may be similar to server device 20 as shown in FIG. 3 or include any or all of the features depicted for server device 20 as shown in FIG. 3. Server device 20 may also be implemented among multiple machines as a data center or a virtual server, for example.

As shown in the example of FIG. 3, server device 20 includes one or more processors 60, memory 62, a network interface 64, one or more storage devices 66, input device 68, and output device 70. Server device 20 may include one or more of any of these components, and one or more types or sub-components of any of these components. Server device 20 also includes an operating system 74 that is executable by server device 20. Server device 20, in the example of FIG. 3, further includes web server 22 that is also executable by server device 20. Each of components 60, 62, 64, 66, 68, 70, 74, 76, 34, 32, 30, 44, 36, 40, 42, 38, and 46 may be interconnected physically, communicatively, and/or operatively by communication channels 72A, 72B for inter-component communications. Communication channels 72A, 72B may include any type of bus, communication fabric, or other type of element for communicating data.

Processors 60, in one example, are configured to implement functionality and/or process instructions for execution within server device 20. For example, processors 60 may be capable of processing instructions stored in memory 62 or instructions stored on storage devices 66.

Memory 62, in one example, is configured to store information within server device 20 during operation. Memory 62, in some examples, may be described as a computer-readable storage medium. In some examples, memory 62 is a temporary memory, meaning that long-term storage is not a primary purpose of memory 62. Memory 62, in some examples, may be a volatile memory, such that memory 62 does not maintain stored contents when the computer is turned off. This may include random access memory (RAM), dynamic random access memory (DRAM), static random access memory (SRAM), and other forms of volatile memory known in the art. In some examples, memory 62 is used to store program instructions for execution by processors 60. Memory 62, in one example, may be used by software or applications running on server device 20 (e.g., applications 76) to temporarily store information during program execution.

Storage devices 66, in some examples, may also include one or more computer-readable storage media. Storage devices 66 may be configured to store larger amounts of information than memory 62. Storage devices 66 may further be configured for long-term storage of information. In some examples, storage devices 66 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Server device 20, in some examples, also includes a network interface 64. Server device 20, in one example, utilizes network interface 64 to communicate with external devices via one or more networks, such as one or more wireless networks. Network interface 64 may include a network interface card, such as an Ethernet card, an optical transceiver, a radio frequency transceiver, or any other type of device that can send and receive information. Other examples of such network interfaces may include Bluetooth®, 3G and WiFi® radios in mobile computing devices, as well as Universal Serial Bus (USB). In some examples, server device 20 utilizes network interface 64 to wirelessly communicate with an external device such as client computing device 12 and computing devices 52A-D of FIGS. 1 and 2.

Server device 20, in one example, also includes one or more input devices 68. Input device 68, in some examples, may be configured to receive input from a user. Examples of input device 68 include a keyboard, a mouse, or any other type of device for detecting inputs from a user.

One or more output devices 70 may also be included in server device 20. Output device 70, in some examples, is configured to provide output to a user using video, audio, or other forms of output. Output device 70, in one example, may utilize a sound card, a video graphics adapter card, or any other type of device for converting a signal into an appropriate form understandable to humans or machines. Additional examples of output device 70 may include a liquid crystal display (LCD), a cathode ray tube (CRT) monitor, a speaker, or any other type of device that can generate intelligible output to a user.

Server device 20 may include operating system 74. Operating system 74, in some examples, controls the operation of components of server device 20. For example, operating system 74, in one example, facilitates the interaction of one or more applications 76 (e.g., web server 38) with processors 60, memory 62, network interface 64, storage device 66, input device 68, and output device 70.

As shown in FIG. 3, web server 22 may include automated store merchandising (ASM) module 30, subgroup mapping transition center (TC) module 32, merchandising grid (MG) module 36, visual merchandising tool (VMT) module 40, and rules maintenance application (RMA) module 44, as described above with reference to FIG. 1. Applications 76, web server 38, ASM module 30, TC module 32, MG module 36, VMT module 40, and RMA module 44 may each include program instructions and/or data that are executable by server device 20. ASM module 30, TC module 32, MG module 36, VMT module 40, and RMA module 44 may include instructions that cause web server 22 executing on server device 20 to perform any one or more of the operations and actions described in this disclosure.

ASM module 30, TC module 32, MG module 36, VMT module 40, and RMA module 44 are each referred to as “modules” in the most generic sense that they are portions of machine-readable code in any form, and are not limited to any particular form or particular type of machine-readable code. For example, TC module 32 may be a stand-alone subgroup mapping transition center application, ASM module 30 may be a stand-alone automated store merchandising application, and visual merchandising tool module 44 may be incorporated as a method, class, or library that forms part of the subgroup mapping transition center application or is called by the subgroup mapping transition center application, and that makes calls to or otherwise communicates with the automated store merchandising application, in one example. In other examples, TC module 32 and ASM module 30 may each be implemented as one or more modules, methods, classes, objects, libraries, subroutines, or other portions of machine-readable code as part of a larger subgroup mapping application. In still other examples, ASM module 30, TC module 32, MG module 36, VMT module 40, and RMA module 44 may each be stand-alone applications that communicate with each other. In yet other examples, various aspects of any of SM module 30, TC module 32, MG module 36, VMT module 40, and RMA module 44 may be included in a new patch or upgrade to existing software that may already have been loaded on server device 20 but that previously lacked such features.

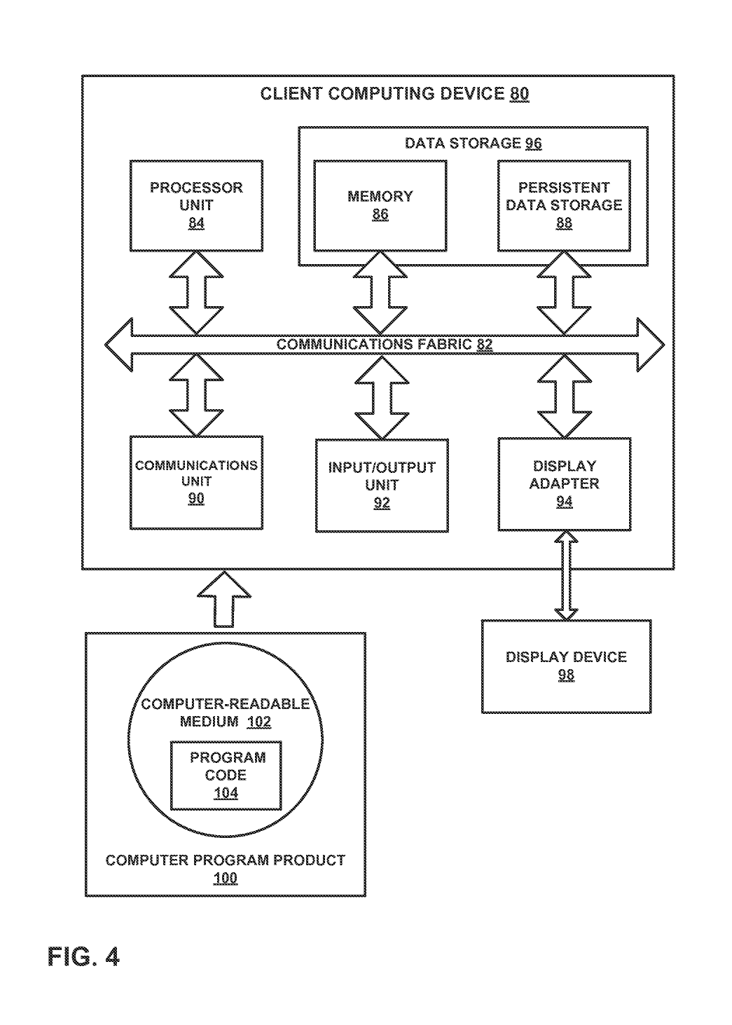

FIG. 4: Example Client Computing Device

FIG. 4 is a block diagram of a computing device 80 that may be used to run a client user interface for an adjacency mapping system, such as client computing device 12 as part of adjacency mapping system 10 of FIG. 1, according to an illustrative example. FIG. 4 provides details of how client computing device 12 of FIG. 1 may provide part of the basis for the functioning of adjacency mapping system 10. An adjacency mapping system may be enabled to perform automated adjacency mapping either by incorporating this capability within a single application, or by making calls and requests to and otherwise interacting with any of a number of other modules, libraries, data access services, indexes, databases, servers, or other computing environment resources, including one or more implementations of computing device 80, for example. Computing device 80 may be a workstation, server, mainframe computer, notebook or laptop computer, desktop computer, tablet, smartphone, feature phone, or other programmable data processing apparatus of any kind Other possibilities for computing device 80 are possible, including a computer having capabilities or formats other than or beyond those described herein.

In this illustrative example, computing device 80 includes communications fabric 82, which provides communications between processor unit 84, memory 86, persistent data storage 88, communications unit 90, input/output (I/O) unit 92, and display adapter 94. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor, an x86 compatible processor, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity in FIG. 4, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, but those skilled in the art will recognize that this also constitutes an example of a physical, tangible, non-transitory computer-readable data storage device. Executable instructions are stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for an adjacency mapping application, as described in greater detail below. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below. The operating system may provide functions such as device interface management, memory management, and multiple task management. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. Some of these examples may overlap with each other, or with example components of communications unit 90 or data storage 96. Input/output unit 92 may also include appropriate device drivers for any type of external device, or such device drivers may reside in the operating system or elsewhere on computing device 80 as appropriate.

Computing device 80 may also include a display adapter 94 in this illustrative example, which provides one or more connections for one or more display devices. Input/output unit 92 may also include appropriate device drivers for any type of external device, or such device drivers may reside in the operating system or elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be connected to display adapter 94 and may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology. Computer program code 104 may include an adjacency mapping application that may include various modules such as an automated store merchandising (ASM) module 30, a subgroup mapping transition center (TC) module 32, a merchandising grid (MG) module 36, a visual merchandising tool (VMT) module 40, and a rules maintenance application (RMA) module 44, as indicated above with reference to FIGS. 1 and 3.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84. The physical program code signal thereby physically causes processor unit 84 to generate physical outputs that correspond to the computer-executable instructions, in a way that modifies computing device 80 into a new physical state and causes computing device 80 to physically assume new capabilities that it did not have until its physical state was changed by loading the executable instructions comprised in program code 104.

In some illustrative examples, program code 104 may be downloaded over a network to data storage 96 from another device or computer system, such as a server, for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

Aspects of this disclosure may be embodied as a method, a computing system, or a computer program product, for example. Accordingly, aspects of this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, aspects of the present invention may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible, non-transitory data storage medium, as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wireline, optical fiber cable, etc., or any suitable combination of the foregoing. Computer program code for carrying out operations for aspects of the present invention may be written in any of one or more programming languages, such as Java, C, C++, C#, Python, Ruby, Scala, or Clojure, among a variety of illustrative examples. One or more sets of applicable program code may execute partly or entirely on the user's desktop or laptop computer, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures.

A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

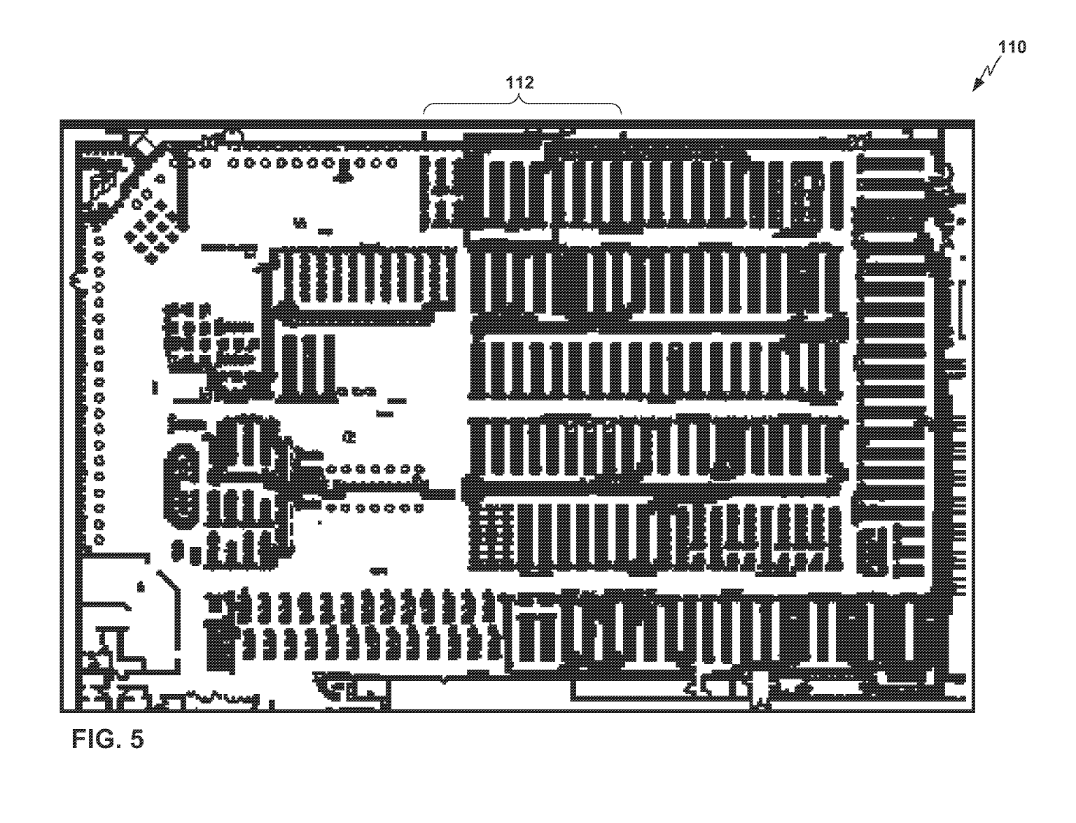

FIG. 5: Individualized Subgroup Mapping

FIG. 5 is a physical store layout graphical output 110 representing physical store layout data for a store, that may be provided in a user interface, such as subgroup mapping transition interface 16 of FIGS. 1 and 2, for an adjacency mapping system in accordance with aspects of this disclosure. The physical store layout data represented in store layout graphical output 110 may include architectural plans and positions and dimensions of walls, shelves, racks, and other merchandising fixtures, for a specific store layout. The physical store layout data represented in store layout graphical output 110 may be stored along with stored layout data for other store layouts in store layout data store 42 of FIGS. 1 and 3, for example.

Different stores may have various different store layouts. A specific store layout may have at least some standardized product adjacency group layouts applicable to multiple stores, or a unique store layout that may have product adjacency group layouts that apply only to a single store. Some product adjacency group layouts may be applicable to different stores with very minor variations, such as minor variations in the position of a door in a wall, while some product adjacency group layouts may differ greatly from any other store layouts in a store layout data store. A retail enterprise may have a number of different standardized product adjacency group layouts, each of which may apply to multiple stores that conform to the detailed physical store layout specifications for that particular standardized product adjacency group layout. A retail enterprise may have a number of stores with atypical or unique physical store layouts, such as older stores that pre-date a layout standardization, or stores installed in legacy structures that were not originally constructed by the retail enterprise and that may have product adjacency group layouts that are unique compared with the rest of the stores belonging to the retail enterprise.

A store layout data store may contain data for each of the physical store layouts for each of the stores belonging to the retail enterprise. The store layout data store may also contain data for an index or a correspondence that indicates which of the stored physical store layouts correspond to which stores. Some physical store layouts may include layout data for standardized product adjacency group layouts that apply to a potentially large number of stores, while some physical store layouts may be for stores that are atypical or unique, and have product adjacency group layouts that correspond to only a small number of stores or a single store.

This variety of physical store layouts may affect the mapping of product subgroups in an adjacency group in a variety of ways. For example, the retail enterprise may have a number of standardized product adjacency group layouts in a range of sizes, and the size of an individual adjacency group may be calibrated to the size of the store. The store layout data may include standardized layouts for relatively smaller stores and for larger stores. The product adjacency group layouts may also include variation layouts with data indicating minor exceptions to a standardized product adjacency group layout stored along with an indication of a standardized layout that the exceptions are applied to.

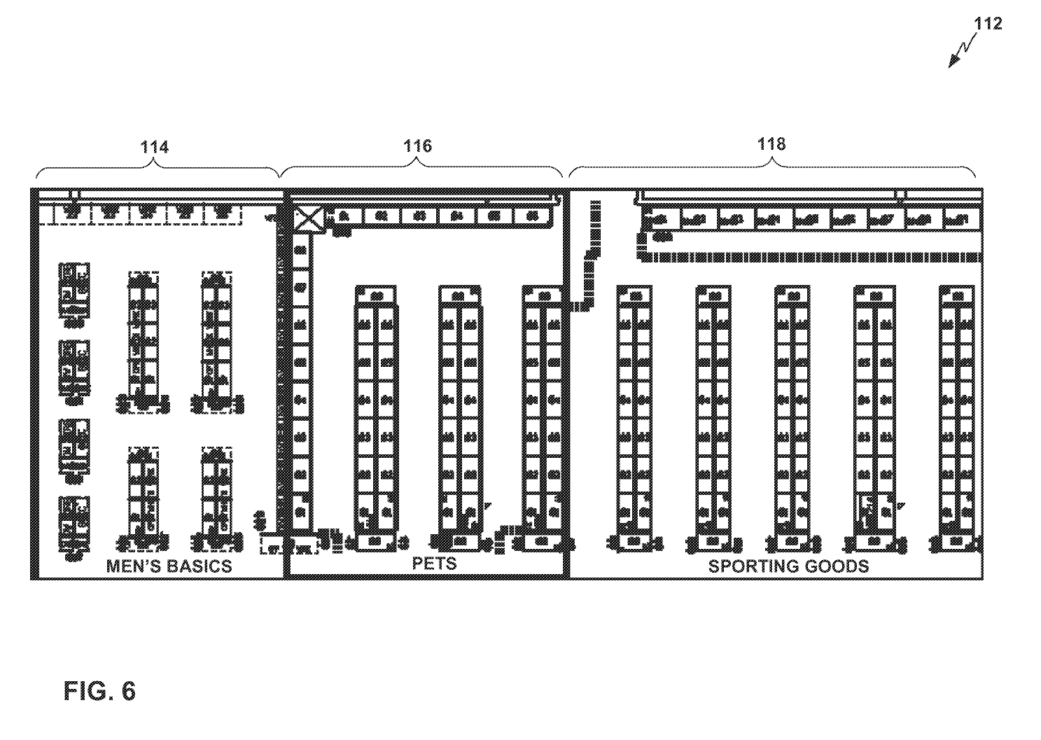

The physical store layout may be assigned different sections that define adjacency groups. A layout portion 112 of physical store layout graphical output 110 may be used as a representative example to illustrate the assignment of different sections of a store layout into different adjacency groups, as further illustrated in FIG. 6.

FIG. 6 is a graphical output representing physical store layout data for a portion of a store layout 112, that may be provided in a user interface, such as subgroup mapping transition interface 16 of FIGS. 1 and 2, for an adjacency mapping system in accordance with aspects of this disclosure. Store layout portion 112 includes smaller portions of the store layout that have been segmented into product adjacency groups, in particular, a “Men's Basics” adjacency group 114, a “Pets” adjacency group 116, and a “Sporting Goods” adjacency group 118. A product adjacency group may be a portion of a store layout that is assigned to a particular division, category, or department of products that are logically categorized together in a group, and/or that may be advantageously grouped and presented together or in adjacent groups for merchandising purposes. An adjacency group may be for a product division that contains multiple product categories and/or departments that corresponds to a logical arrangement that may conform to retail customer expectations about what to find together, or that may be conducive to cross-selling related products for a retail customer seeking a particular product, for example. Various factors considered for organizing adjacency groups may include data and patterns on sales volume, location attributes, and customer demographics for particular product categories, for example.

The categorization of products into hierarchical levels of relatedness, such as into adjacency groups, may be designed in accordance with substantial market research. The categorization of products into levels of relatedness such as adjacency groups may be stored as data in product data store 38, for example. Product data store 38 may also store extensive data on each individual product, such as the individual product's size and dimensions, weight, normal price, markdown price, vendor, SKU number, forecasted popularity, inventory policy, and so forth, for example.

The portion of a store layout assigned to a particular adjacency group may be considered the floorpad of that adjacency group. The floorpad for the adjacency groups 114, 116, and 118, as represented in the store layout includes layout in FIG. 6, of shelves, racks, and other merchandising fixtures derived from the store layout data, and that correspond to the physical arrangement and dimensions of the actual merchandising fixtures in the physical stores.

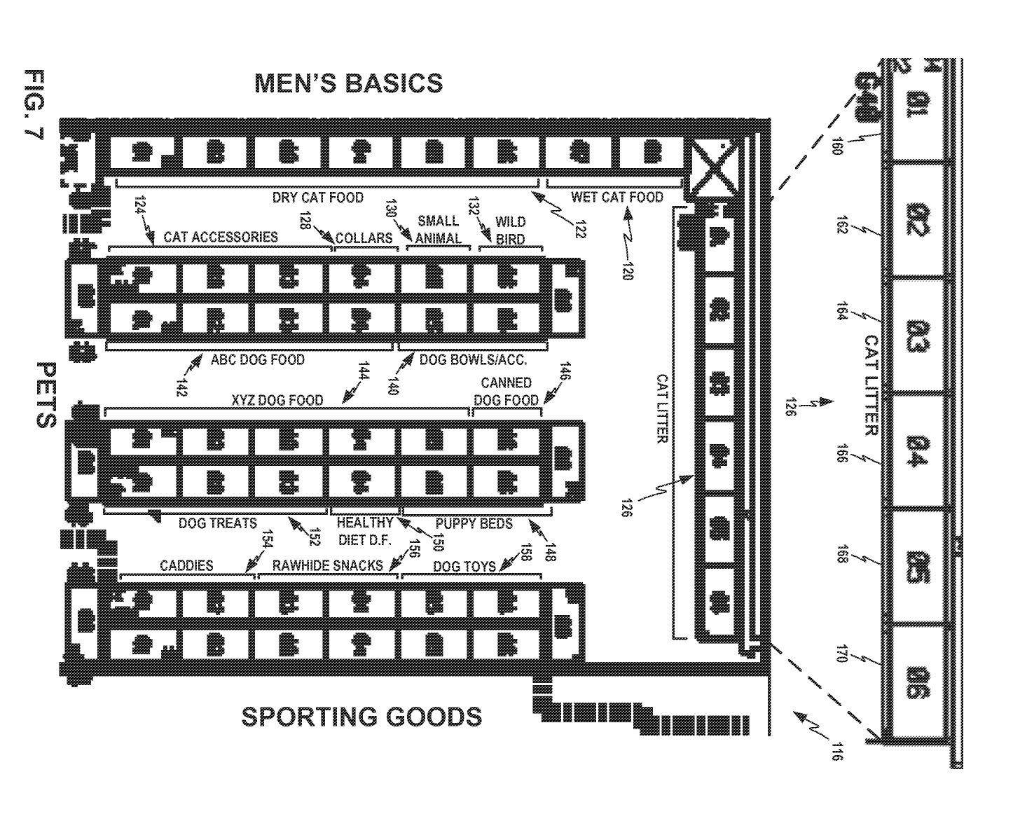

FIG. 7 is a graphical output of a product subgroup map for the “Pets” product adjacency group 116 within the store layout of a store. The product subgroup map for product adjacency group 116 may be provided in a user interface, such as subgroup mapping transition interface 16 of FIGS. 1 and 2, for a visual merchandising tool (VMT) module, such as VMT module 40 of FIGS. 1 and 3, of an adjacency mapping system in accordance with aspects of this disclosure. A product subgroup may be a narrower level of categorization within a product adjacency group, such as a single category or family of products within a product division, for example, such as the illustrative product subgroups shown mapped in FIG. 7. For purposes of FIG. 7, the reference number 116 may refer both to the “Pets” adjacency group in general, and to the rendering of the product subgroup map for the “Pets” adjacency group, with the product subgroup mapping assignments superimposed on the store layout section assigned to the product adjacency group as depicted in FIG. 7.

The product subgroup map 116 is a map of where different product subgroups are positioned or are intended to be positioned within the “Pets” product adjacency group. As shown in FIG. 7, the floor plan assigned to the “Pets” product adjacency group shows rows of structures that represent shelves, racks, and/or other merchandising fixtures, and these merchandising fixtures are divided into many separate sections. Each of the product subgroups are assigned to one or more of these sections, as shown in FIG. 7. This mapping of each product subgroup to one or more sections of the merchandising fixtures in the “Pets” adjacency group is shown in an exploded view of one of the particular product subgroups, the “cat litter” product subgroup 126 seen at the top of FIG. 7. The “cat litter” product subgroup 126 included six different, adjacent merchandising fixture sections 160, 162, 164, 166, 168, 170 (“fixture sections 160-170”). Each of fixture sections 160-170 may represent a certain area of merchandising fixtures. For example, each of fixture sections 160-170 may represent a four-foot-wide section of a column of shelves or racks assembled against a wall. Many or all of the other fixture sections depicted in FIG. 7 may each also represent a four-foot-wide section of a column of shelves or racks assembled against either a wall or a free-standing gondola that is positioned on the floor apart from a wall but that also supports shelves, racks, or other merchandising fixtures. In other examples, other sizes or dimensions of sections of merchandising fixtures or merchandising space may also be used.

Product adjacency groups such as the “Pets” product adjacency group 116 and product subgroups such as the “cat litter” product subgroup 126 and the other product subgroups mapped out in the “Pets” product adjacency group 116 as shown in FIG. 7 therefore form part of a hierarchical planning organization for merchandising products in a retail store space. This hierarchical organization of product merchandising may also extend down to another, finer level of detail below the level of the product subgroups, where each individual product subgroup may be associated with a corresponding planogram. A planogram may be a mapping of individual products and how these individual products are displayed or presented within a particular product subgroup.

Whereas the product adjacency groups and product subgroups may be mapped from a vertical, bird's-eye view perspective of the floor plan of the store layout, a planogram may be mapped from a horizontal view corresponding to the view of a customer standing in the store looking at the products as they are positioned in or on the merchandising fixtures in any given product subgroup. Each fixture section, such as fixture sections 160-170, in a product subgroup may therefore correspond one-to-one with a particular planogram that shows a map of where and how all of the products intended for that fixture section are intended to be arranged on the merchandising fixtures in that product subgroup. A fixture section may therefore also be referred to as a planogram section. Taken together, therefore, the organizational levels of products adjacency groups, product subgroups, and planograms may provide a comprehensive and logical hierarchical organizational structure for planning and assigning how all of the available products may be positioned in a logical and coherent manner throughout a retail store. A product subgroup may therefore be a business title to refer to planogram footage and display information for particular categories of products.

As shown in FIG. 7, the product subgroup map 116 for the “Pets” product adjacency group includes a wet cat food product subgroup 120 and a dry cat food product subgroup 122 arranged along one gondola wall, with the wet cat food product subgroup 120 mapped to two adjacent planogram sections, and the dry cat food product subgroup 122 mapped to six contiguous planogram sections adjacent to the wet cat food product subgroup 120 along the gondola wall, with that gondola wall intersecting the architectural wall along which the “cat litter” product subgroup is mapped. The “Pets” product subgroup map 116 also includes a “cat accessories” product subgroup 124 with three planogram sections, and a “collars” product subgroup 128, a “small animal” product subgroup 130, and a “wild bird” product subgroup 132, each with one planogram section, where these four product subgroups are arranged along a gondola wall opposite the wet cat food product subgroup 120 and a dry cat food product subgroup 122, all on a single aisle formed between the two corresponding gondola walls.

As shown in FIG. 7, the product subgroup map 116 for the “Pets” product adjacency group includes second and third aisles. The second aisle contains a “dog bowls and accessories” product subgroup 140, an “ABC brand dog food” product subgroup 142, an “XYZ brand dog food” product subgroup 144, and a “canned dog food” product subgroup 146. The third aisle contains a “puppy beds” product subgroup 148, a “healthy diet dog food” product subgroup 150, a “dog treats” product subgroup 152, a “caddies” product subgroup 154, a “rawhide snacks” product subgroup 156, and a “dog toys” product subgroup 158. Each of these product subgroups is also assigned one or more particular planogram sections within the merchandising fixtures rendered in the store layout portion of the “Pets” product adjacency group. The product subgroup map 116 for the “Pets” product adjacency group therefore provides a detailed map for where each of several product subgroups are to be presented for merchandising display within the portion of a store layout assigned to the “Pets” product adjacency group.

The retail enterprise may regularly have a need to reorganize the merchandising presentation of products, such as the products within the “Pets” product adjacency group. For example, sales and marketing data may indicate that demand for certain products or product categories is increasing while demand for other products or product categories is decreasing. For example, a retail enterprise may discover that demand for and sales of healthy diet dog food have recently been increasing rapidly. Sales and marketing data may also reveal newly discovered cross-dependencies or patterns showing that sales of a certain product subgroup are higher or lower when positioned immediately side-by-side with another certain product subgroup, or that some product subgroups tend to sell the same volume whether they are positioned adjacent to a higher-traffic end-cap next to a higher-traffic walking lane or positioned against a wall that is more out-of-the-way, while other product subgroups have much better sales when positioned adjacent to a higher-traffic end-cap than when positioned on an out-of-the-way wall. For example, a retail enterprise may discover that caddies tend to sell the same volumes whether placed adjacent to a high-traffic end-cap or against a low-traffic wall, while dog accessories tend to sell much better when placed in a position of high traffic and high visibility, such as adjacent to an end-cap next to a major walking lane through the store, than when placed in a low-traffic area. A retail enterprise may also find a need to reorganize product merchandise display to showcase seasonally relevant products, to highlight a new product line, or to launch a product line from a new vendor, for example.

The retail enterprise may therefore plan to implement a “transition” or merchandising transition, where a “transition” is a reorganization of where and how various products are positioned and arranged for display in a retail store. A transition is therefore important for sales and marketing purposes, but may also be complicated to plan and disruptive to implement. The retail enterprise may typically place a high priority on implementing a transition at the same time across several or all of its retail stores, to maintain consistency in its merchandising across all of its retail stores. A transition may require stocking new inventory or rebalancing the inventory load across various products, in all of the enterprise's retail stores at the same time. Implementing a transition on the sales floor of a retail store may also be disruptive as it requires team members to remove and rearrange potentially large volumes of products from merchandising fixtures, requiring potentially substantial amounts of labor, and potentially interfering with merchandising and sales if the transition process interrupts operations during times when a store is open or business. Additionally, just the process of planning a transition has typically been a labor-intensive manual process, where the required labor is compounded by trying to plan transitions that serve the same goals and are consistent with each other across a wide range of sizes, arrangements, and architectural plans of stores.

Aspects of this disclosure may simplify, facilitate, and greatly accelerate a merchandising transition process and help maximize the goals of a transition while minimizing its burdens, by automating a process of organizing a transition while automatically applying a weighted balancing among numerous goals to be achieved and drawbacks to be minimized in the transition, as further described below with reference to the subsequent figures.

For example, a retail enterprise may have new sales and marketing data about products in the “Pets” adjacency group, as suggested above, as well as other factors motivating a need for reorganizing the merchandising, so that the enterprise wants to initiate a new transition of the product subgroup map of the “Pets” adjacency group, and transition away from product subgroup map 116 as depicted in FIG. 7 to a new product subgroup map that implements the advantages of the new sales and marketing data in the merchandising of the products in the “Pets” adjacency group. To begin this merchandising transition process, with reference again to FIGS. 1-4, user 11 may use client computing device 12 to engage with subgroup mapping transition user interface 16 to initiate a transition. Transition user interface 16 is so named since it may serve as a user interface for initiating and organizing these merchandising transitions.

As used throughout this disclosure, a product subgroup may be referred to simply as a “subgroup” for short, with the understanding that this refers to a product subgroup; a product adjacency group may be referred to simply as an “adjacency group” or an “adjacency” for short, with the understanding that this refers to a product adjacency group; a merchandising transition may be referred to simply as a “transition” for short, with the understanding that this refers to a merchandising transition; and a particular state and/or rendering of transition user interface 16 of FIGS. 1 and 2 may be referred to simply as a “user interface”.

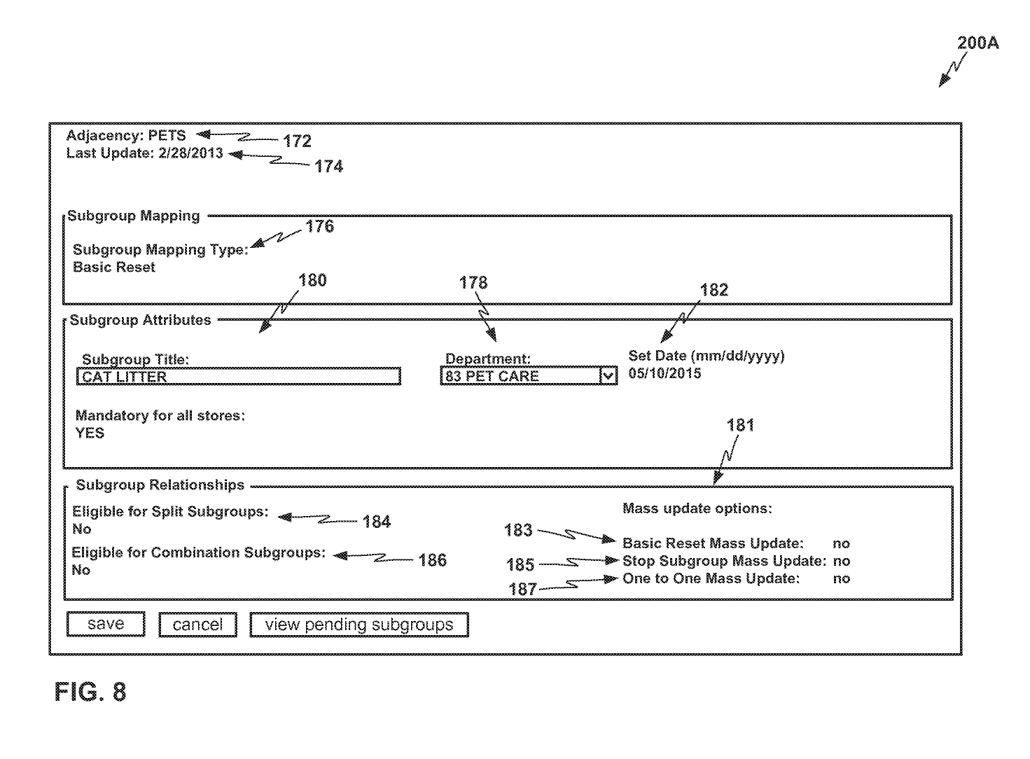

FIG. 8 is a graphical output of an aspect of a user interface 200A, which may correspond with a particular state and rendering of transition user interface 16, for single subgroup mapping with a transition center (TC) module 32 of an adjacency mapping system 10 in accordance with aspects of this disclosure. Transition user interface 16 may render user interface 200A at the beginning of a transition initiating process with user 11. Subgroup mapping transition center (TC) module 32 may provide and coordinate outputs from, and receive and convey user inputs to, the other modules, data stores, and components of adjacency mapping system 10. Transition user interface 200A includes an adjacency indication 172 showing that user 11 has selected the “Pets” adjacency in which to initiate a transition. Transition user interface 200A may include a last update indication 174, a subgroup mapping type 176, and a product department 178, which may correspond to the selected “Pets” adjacency. The last update indication 174 shows the date that the product subgroup mapping was last updated, i.e., the last time a transition was performed for the adjacency group. Product departments may be categorizations of products from other business units that may be the same or similar or different organizational groupings of products relative to adjacency groups, for example.

Transition user interface 200A may show a subgroup title indication 180 that may be a field or drop-down menu for a user to enter or select a product subgroup title. As shown in particular at subgroup title indication 180, user 11 has selected the “cat litter” subgroup, which may be one of several subgroups that may be selected for inclusion in the presently initiated transition. As shown at subgroup relationship indications 184 and 186, subgroups may or may not be selected to be eligible to be split or combined. Set date indication 182 shows a user-selectable date on which to implement a transition for the selected subgroups in the selected adjacency. In the description of the remaining figures, the transition being currently organized in the transition organization and implementation process being described may be referred to simply as “the transition being initiated”, “the current transition”, or “this transition”, for example. Transition user interface 200A may also display user options for mass updates 181, that involve selecting a single subgroup mapping type and multiple subgroups to which to apply the single subgroup mapping type. These options include a basic reset mass update option 183 that applies a basic reset subgroup mapping type to multiple subgroups; a stop subgroup mass update 185 that applies a stop subgroup mapping type to multiple subgroups; and a one to one mass update 187 that applies a one to one subgroup mapping type to multiple subgroups, in this example.

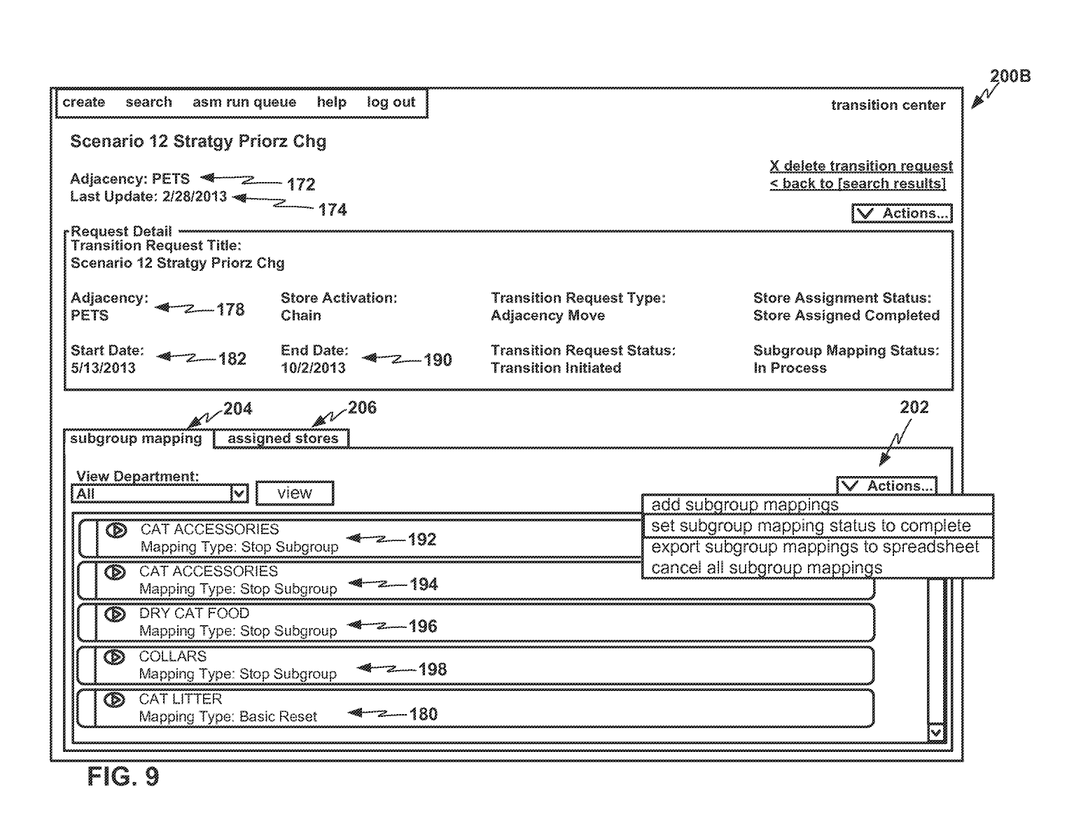

FIG. 9 is a graphical output of an aspect of a user interface 200B for a subgroup mapping summary with a transition center (TC) module 32 of an adjacency mapping system 10 in accordance with aspects of this disclosure. User interface 200B displays a subgroup mapping tab 204, which is currently open in the view of FIG. 9, and an assigned stores tab 206. The subgroup mapping tab 204 being open provides a list or portion of a list of selected subgroups to include in a transition, including “cat accessories” subgroup listing 192, “wet cat food” subgroup listing 194, “dry cat food” subgroup listing 196, “collars” subgroup listing 198, and “cat litter” subgroup listing 180, corresponding to the “cat litter” subgroup title indication 180 as shown in FIG. 8. This may be a partial view of a list of all the subgroups in the “Pets” adjacency that user 11 has so far selected to include in the transition being planned.

User interface 200B also includes user-selectable start date indication 182 and end date indication 190, as well as an action menu 202, which is illustratively depicted with a menu item “set subgroup mapping status to complete” that is being selected by the user. As shown in FIG. 9, action menu 202 also illustratively includes example options for “add subgroup mappings”, “export subgroup mappings to spreadsheet application”, and “cancel all subgroup mappings”.

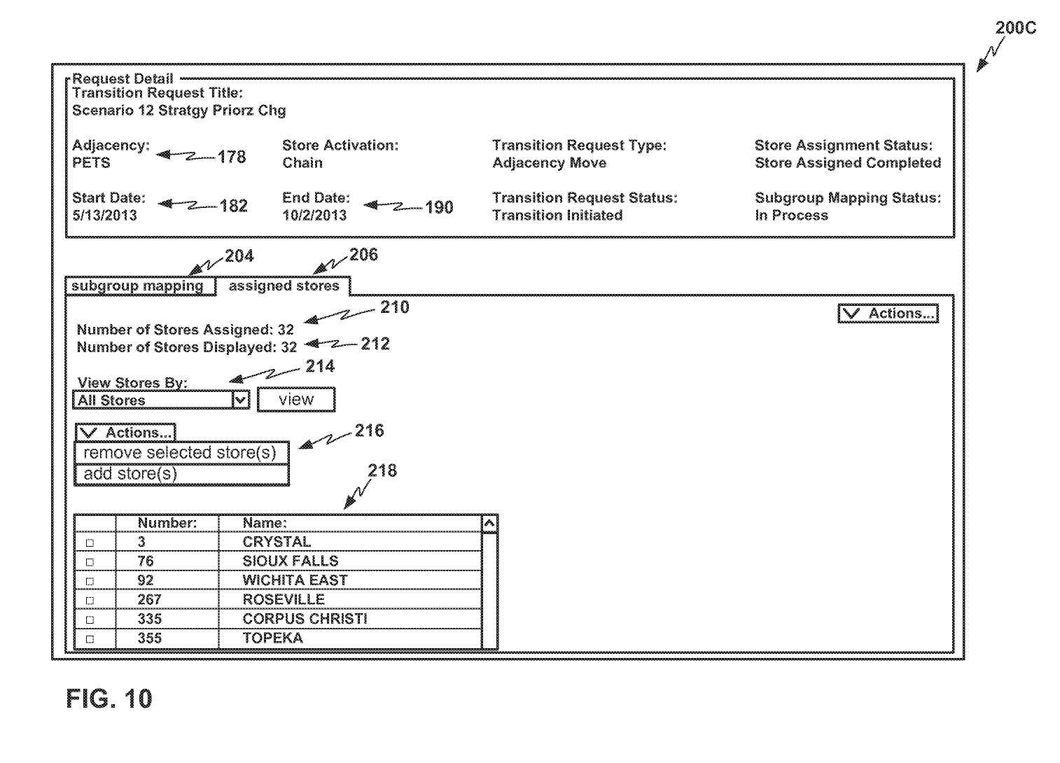

FIG. 10 is a graphical output of an aspect of a user interface 200C for store assignment add and remove with a transition center (TC) module 32 of an adjacency mapping system 10 in accordance with aspects of this disclosure. User interface 200C shows assigned stores tab 206 selected, which renders an indication 210 for of a number of stores assigned to the transition being initiated, an indication 212 for a number of stores displayed, and a menu 214 for “view stores by” which is selected for “all stores”. User interface 200C also shows a store list 218 that lists a number of physical store locations that have been selected for this transition to apply to this transition, and an action menu 216 with options to “remove selected store(s)” or “add store(s)”.

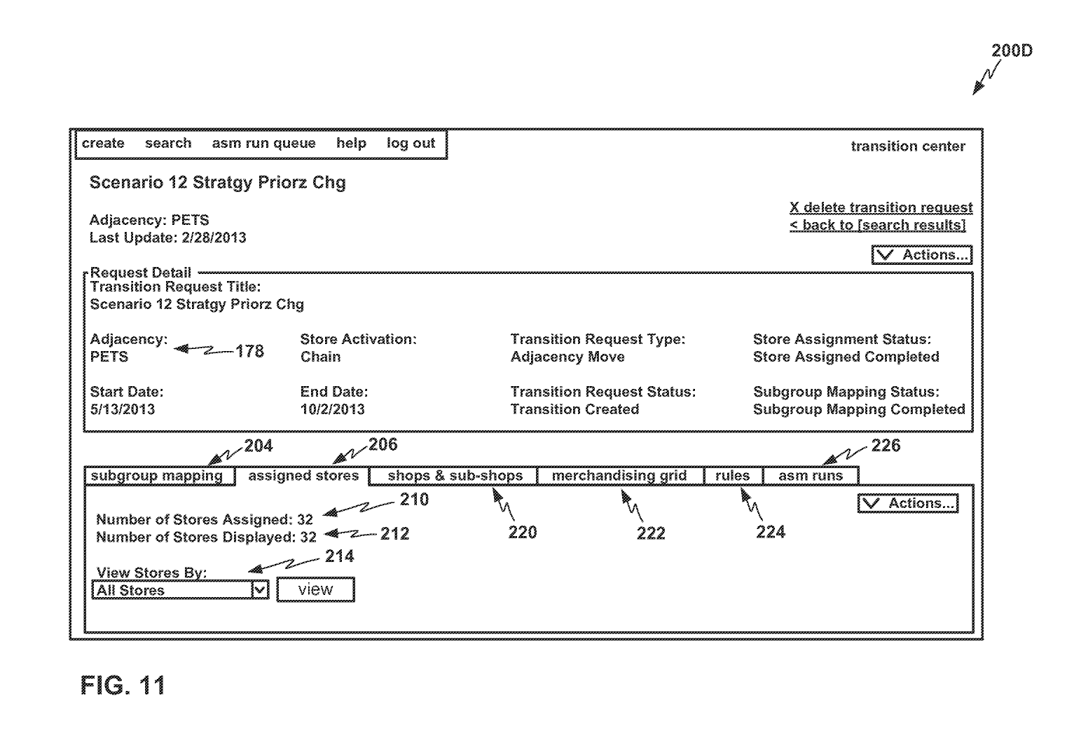

FIG. 11 is a graphical output of an aspect of a user interface 200D for store assignment with a transition center (TC) module 32 of adjacency mapping system 10 in accordance with aspects of this disclosure. User interface 200D displays subgroup mapping tab 204 and assigned stores tab 206 as well as shops and sub-shops tab 220, merchandising grid tab 222, rules tab 224, and ASM runs (i.e. automated store merchandising (ASM) runs) tab 226, which may be displayed once the store assignments are completed under assigned stores tab 206, for example. With assigned stores tab 206 still selected, user interface 200D also still displays the indication 210 for of a number of stores assigned to the transition, an indication 212 for a number of stores displayed, and a menu 214 for “view stores by”.

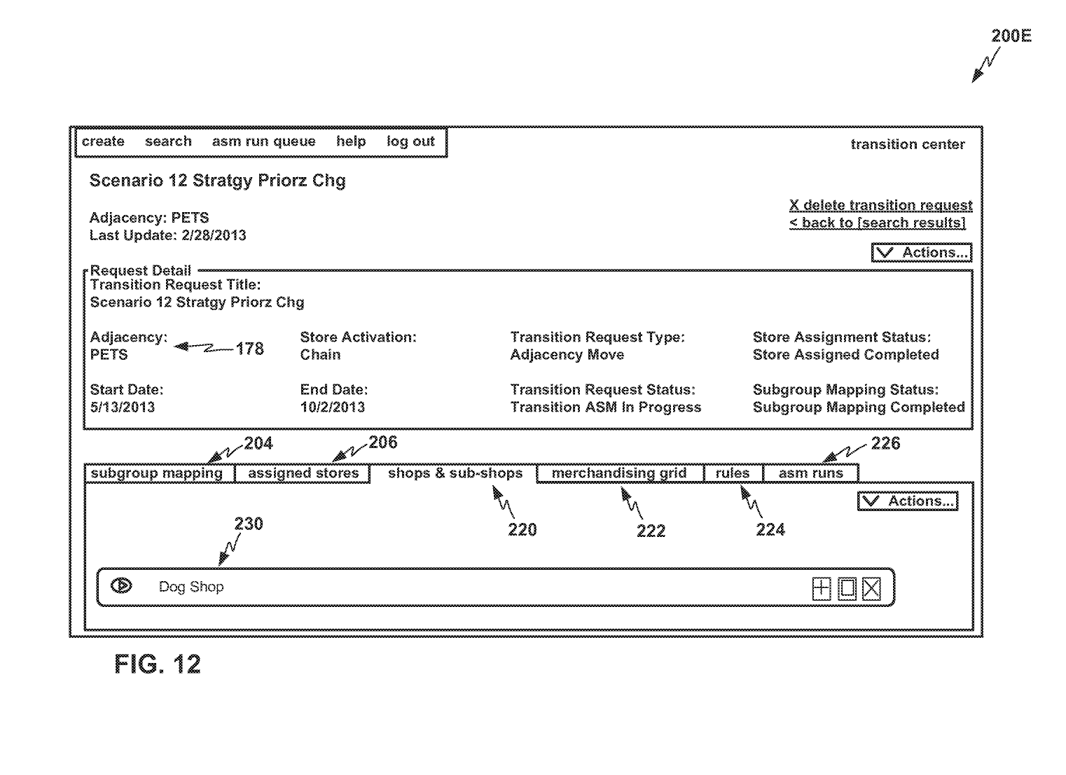

FIG. 12 is a graphical output of an aspect of a user interface 200E for a shops and sub-shops feature in a transition center (TC) module 32 of an adjacency mapping system 10 in accordance with aspects of this disclosure. User interface 200E shows the transition user interface with shops and sub-shops tab 220 selected. Shops and sub-shops tab 220 may enable various product categories with the “Pets” adjacency to be selected, which may include subgroups as well as additional levels of product organization that may be intermediate between the adjacency level and the subgroup level, and/or between the subgroup level and the individual product level. For example, as shown in user interface 200E, this may include a “dog shop” menu item 230 that may define a “shop” level of product organization that groups together various dog-related subgroups, such as dog toys and various dog food subgroups, for example, but excludes non-dog-related subgroups within the “Pets” adjacency. This may provide additional usefulness if the user is keenly interested on a new transition to reorganize the dog-related subgroups, but has less interest at this time in reorganizing the non-dog-related subgroups in the “Pets” adjacency. The shops and sub-shops tab 220 may also expose sub-shop categorizations that may provide yet another organizational level between the shop level and the subgroup level, such as a “dog food” sub-shop that includes only dog-food-related subgroups, for example.

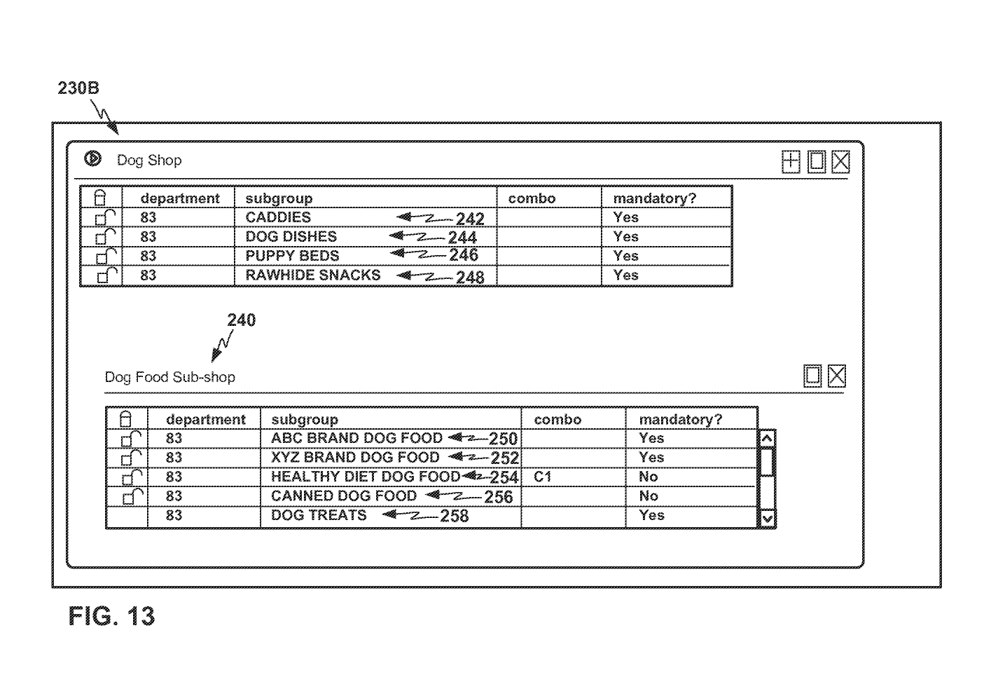

FIG. 13 is a graphical output of an aspect of a user interface 230B for a shops and sub-shops feature in a transition center (TC) module 32 of an adjacency mapping system 10 in accordance with aspects of this disclosure. User interface 230B may render menus that may be opened by selecting the “dog shop” menu item 230 as shown in user interface 200E in FIG. 13, including both a “dog shop” menu 230B and a subordinate “dog food sub-shop” menu 240 organized within the dog shop menu 230B. All of the dog-related subgroups assigned to the dog shop category within the “Pets” adjacency may be listed under the “dog shop” menu item 230, including dog-food-related subgroups that are more specifically listed under the “dog food sub-shop” menu 240. All of these dog-related subgroups may correspond to the similarly named subgroups depicted in product subgroup map 116 in FIG. 7, in this illustrative example. These include a “caddies” subgroup menu item 242, a “dog dishes and accessories” subgroup menu item 244, a “puppy beds” subgroup menu item 246, a “rawhide snacks” subgroup menu item 248, an “ABC brand dog food” subgroup menu item 250, an “XYZ brand dog food” subgroup menu item 252, a “healthy diet dog food” subgroup menu item 254, a “canned dog food” subgroup menu item 256, and a “dog treats” subgroup menu item 258. Each of these subgroup menu items may be selected or de-selected by the user for inclusion in or exclusion from the currently planned transition.

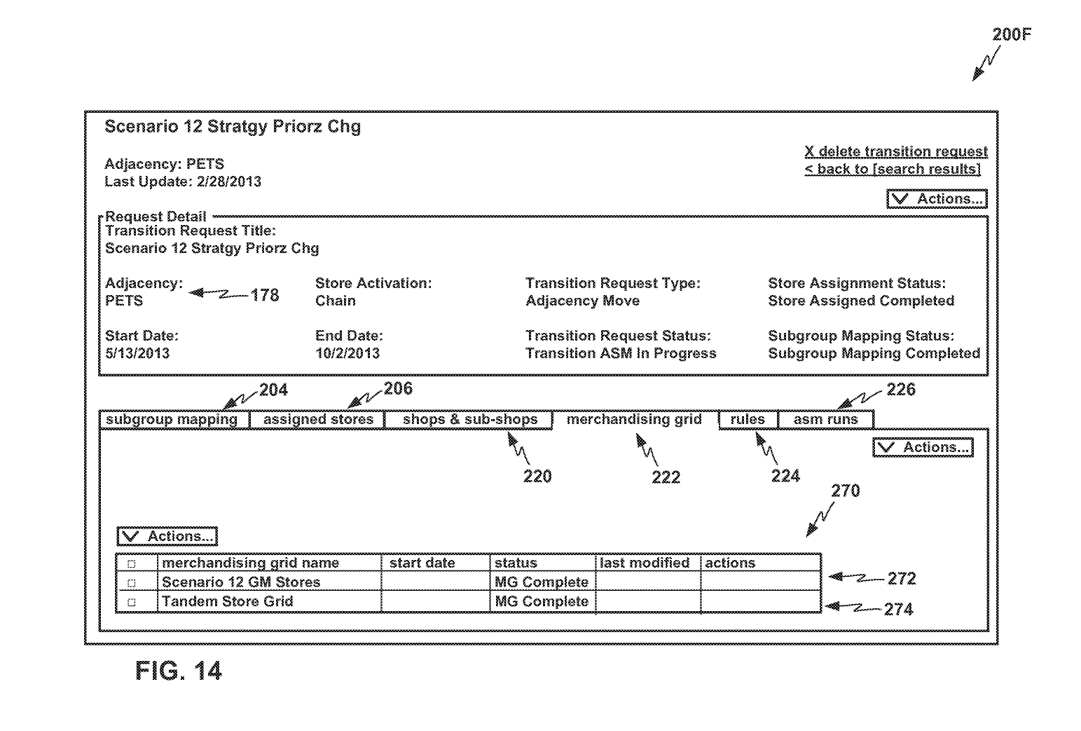

FIG. 14 is a graphical output of an aspect of a user interface 200F for merchandising grid (MG) module 36 of adjacency mapping system 10 in accordance with aspects of this disclosure. FIG. 14 introduces the merchandising grid, selected via merchandising grid tab 222 in transition interface 200F. Transition interface 200F shows a merchandising grid list 270 that may list one or more saved merchandising grids 272, 274, that user 11 or other users may have created and saved at earlier times, and which may be accessed again to modify or re-use. FIG. 14 shows merchandising grid 272, named “Scenario 12”, being selected by the user as an example.

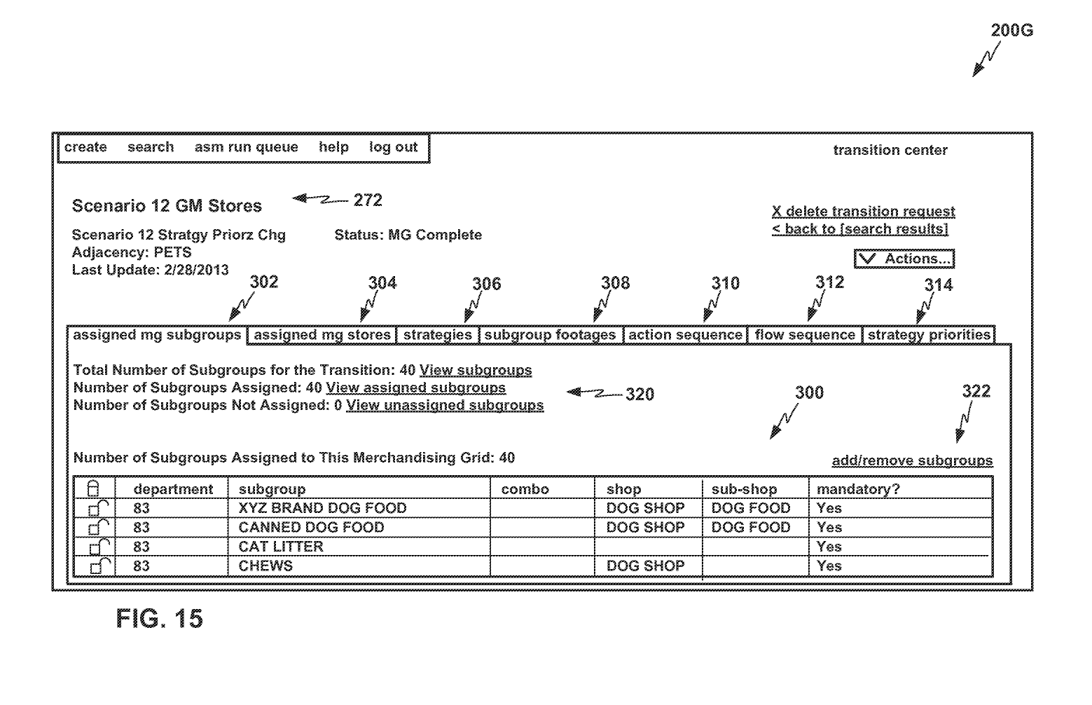

FIG. 15 is a graphical output of an aspect of a user interface 200G for a subgroup assignment function with a merchandising grid (MG) module 36 of adjacency mapping system 10 in accordance with aspects of this disclosure. User interface 200G shows a number of tabs and other user interface elements after the user has selected the “Scenario 12” merchandising grid 272 in transition interface 200F as shown in FIG. 14. User interface 200G includes an assigned merchandising grid subgroups tab 302, an assigned merchandising grid stores tab 304, a strategies tab 306, a subgroup footages tab 308, an action sequence tab 310, a flow sequence tab 312, and a strategy priorities tab 314.

Assigned merchandising grid subgroups tab 302 is currently selected and open in the current state of user interface 200G in FIG. 15, and shows a portion of a merchandising grid 300, which lists all of the subgroups selected for the current transition, including additional data for the selected subgroups such as the shop and/or sub-shop they are also categorized under, if any. User interface 200G also includes a subgroup summary section 320 for merchandising grid 300, which shows a total number of subgroups for the transition, a number of subgroups assigned, and a number of subgroups not assigned. User interface 200G also includes a user interface element (“UI element”) 322 to add/remove subgroups.

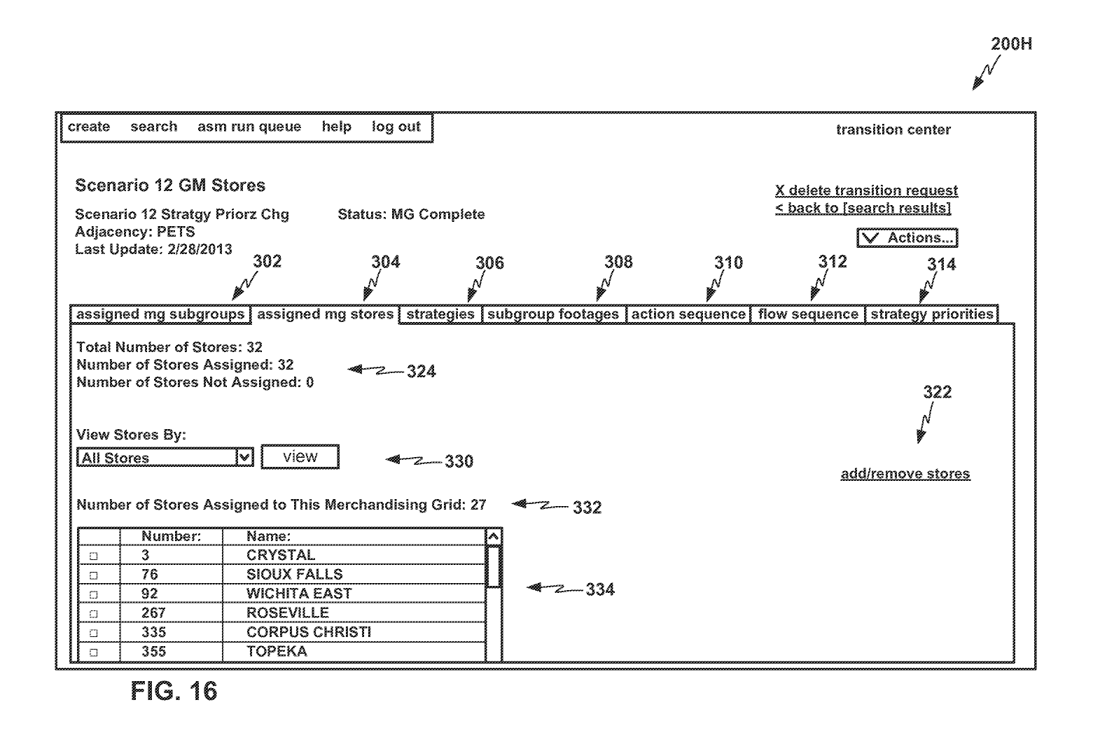

FIG. 16 is a graphical output of an aspect of a user interface 200H for a store assignment function with a merchandising grid (MG) module 36 of an adjacency mapping system 10 in accordance with aspects of this disclosure. User interface 200H shows the assigned merchandising grid stores tab 304 selected. In this state, user interface 200H includes store assignment subgroup summary section 324 for merchandising grid 300 which shows a total number of stores, a number of stores assigned, and a number of stores not assigned. User interface 200H also includes a “view stores by” UI element 330, a UI element 332 for indicating a “number of stores assigned to this merchandising grid”, and a store list 334 of selected stores for the transition. User interface 200H also includes a UI element 322 to add or remove stores. The merchandising grid (MG) module 36 may thereby configure user interface 200H to enable a user to select which stores to apply a current transition to.

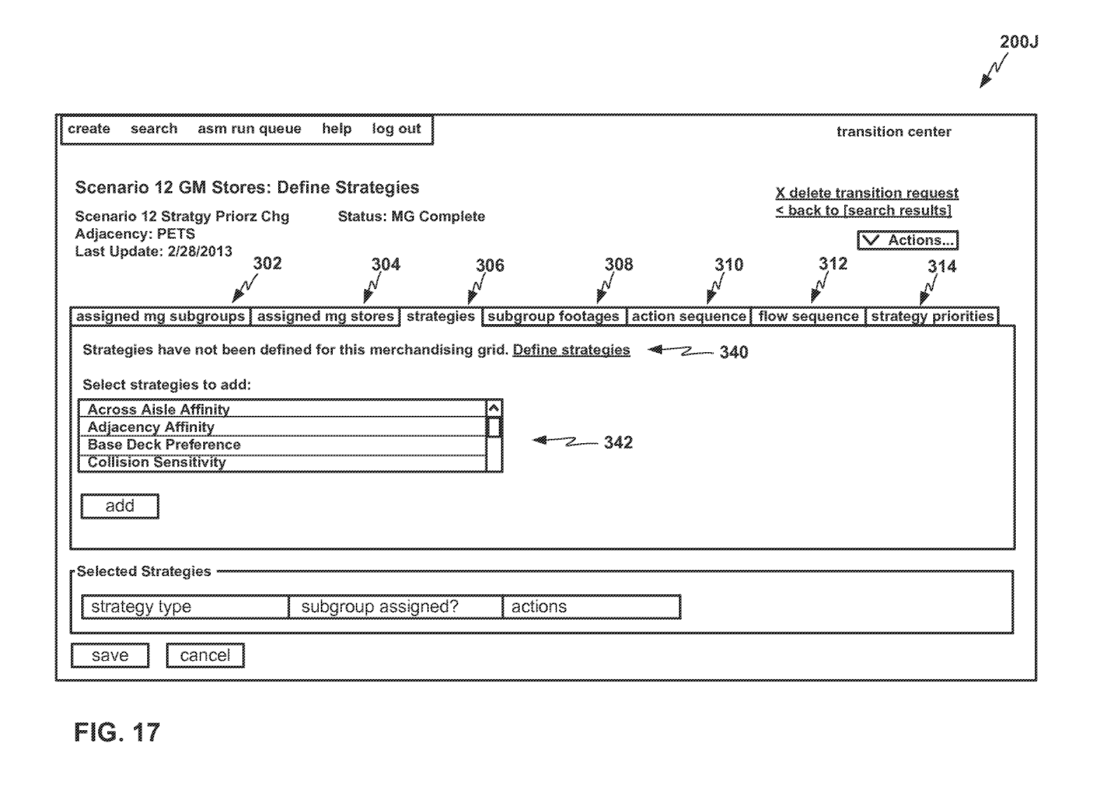

FIG. 17 is a graphical output of an aspect of a user interface 200J for a strategy assignment function of a merchandising grid (MG) module 36 of an adjacency mapping system 10 in accordance with aspects of this disclosure. (The potential reference labels “200I” and “200O” are omitted from use herein to avoid potential confusion.) User interface 200J shows the strategies tab 306 selected, and a UI element 340 to “define strategies”, or to define strategies to apply in the automated process of the transition. User interface 200J includes a strategy list 342 that includes a number of different strategies the user may select from among, illustratively including “across aisle affinity”, “adjacency affinity”, “base deck preference”, and “collision sensitivity”. In the context of these strategies, an “affinity” or a “preference” may indicate an advantageous positioning for a subgroup, while a “collision” indicates a disadvantageous positioning for a subgroup.

For example, an “across aisle affinity” or an “adjacency affinity” indicate that data show that two subgroups complement each other and support each other's sales when in the indicated affinity arrangement of being across the aisle from each other, or within the same adjacency group with each other, respectively. For example, either of these may apply to the dog treats and rawhide snacks subgroups, such that both of these subgroups have higher sales when they are positioned across the aisle from each other and/or within the same adjacency group with each other, for example. A “negative side-by-side affinity”, as another example, indicates a positioning relationship that erodes sales and should be avoided. For example, a perfume subgroup may have lower sales when it is positioned adjacent to the cat litter subgroup. While perfume is not part of the “Pets” adjacency, the subgroup mapping transition center (TC) module 32 may still account for data on what adjacencies and subgroups are positioned outside of a particular adjacency, and implement strategies around that data as well. As another example, the “wild bird” subgroup may also be found to have lower sales when positioned adjacent to a cat food subgroup, and therefore be classified as having a collision sensitivity with the cat food related subgroups. Strategy list 342 may enable a user to select which among several strategies for TC module 32 to apply in the current transition. A “collision sensitivity”, as yet another example, indicates sensitivity to a “collision”, or a physical incompatibility with an irregular merchandising fixture. For example, one four-foot segment of a merchandising display area may have a structural pole that intrudes upon it, and occupies a half-foot width of it, and the merchandising fixtures in that segment must accommodate that physical intrusion. Some product display fixtures may be physically incompatible with such intrusions. As a particular example, special merchandising fixtures may be used to display golf clubs, where the fixtures include four-foot wide retainers for holding the golf clubs horizontally. This special fixture type would make a golf club adjacency group have a collision sensitivity, i.e., a physical incompatibility with a collision merchandising segment.

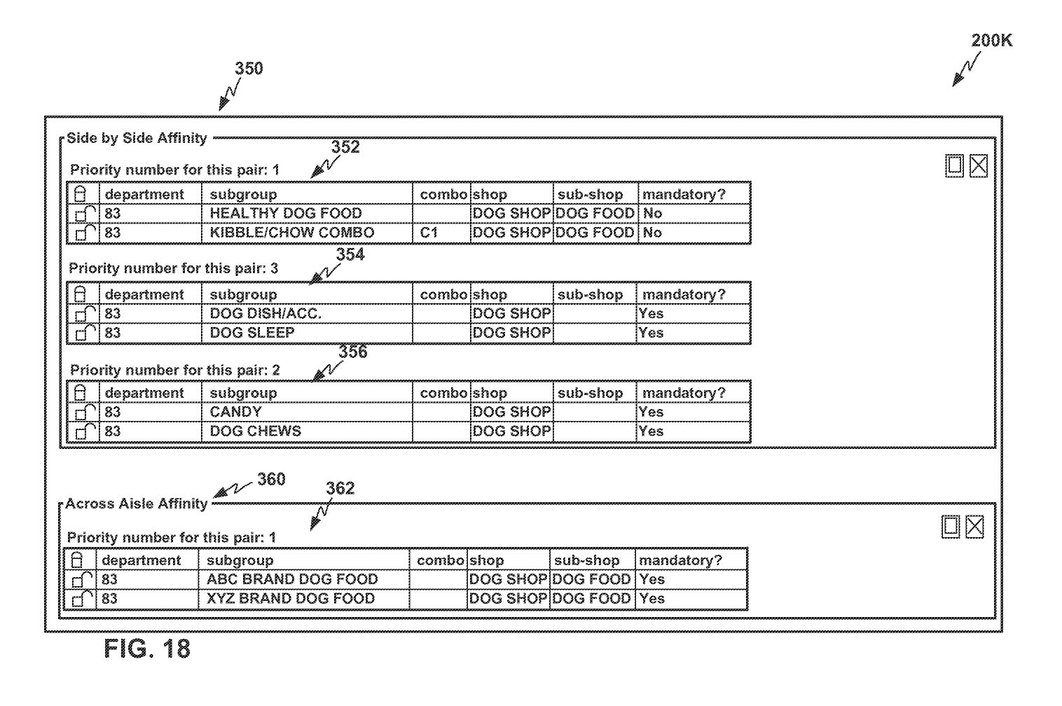

FIG. 18 is a graphical output of an aspect of a user interface 200K for a strategy defining function of a merchandising grid (MG) module 36 of an adjacency mapping system 10 in accordance with aspects of this disclosure. User interface 200K shows a portion of a detailed menu for selecting and applying selected strategies to particular subgroups or pairs of subgroups, and assigning different priorities or priority rankings to different strategies as particularly applied to specific subgroups.

In particular, user interface 200K includes a “side by side affinity” strategy list 350 and an “across aisle affinity” strategy list 360, among many other potential strategy lists for potentially many different strategies that a user may select in user interface 200J of FIG. 17. A side by side affinity is a relation in which presenting two subgroups side by side tends to increase sales, while an across aisle affinity is a relation in which presenting two subgroups across an aisle from each other tends to increase sales, as noted above. “Side by side affinity” strategy list 350 includes three specific pairs of subgroup listings, i.e. subgroup listing pair 352, subgroup listing pair 354, and subgroup listing pair 356, each of which is assigned a priority of 1, 2, or 3, to rank the order of priority of applying the side by side affinity to each of these three pairs. The “across aisle affinity” strategy list 360 includes one listed pair in the view of FIG. 18, but may include more listed pairs out of this view or that the user may yet add.

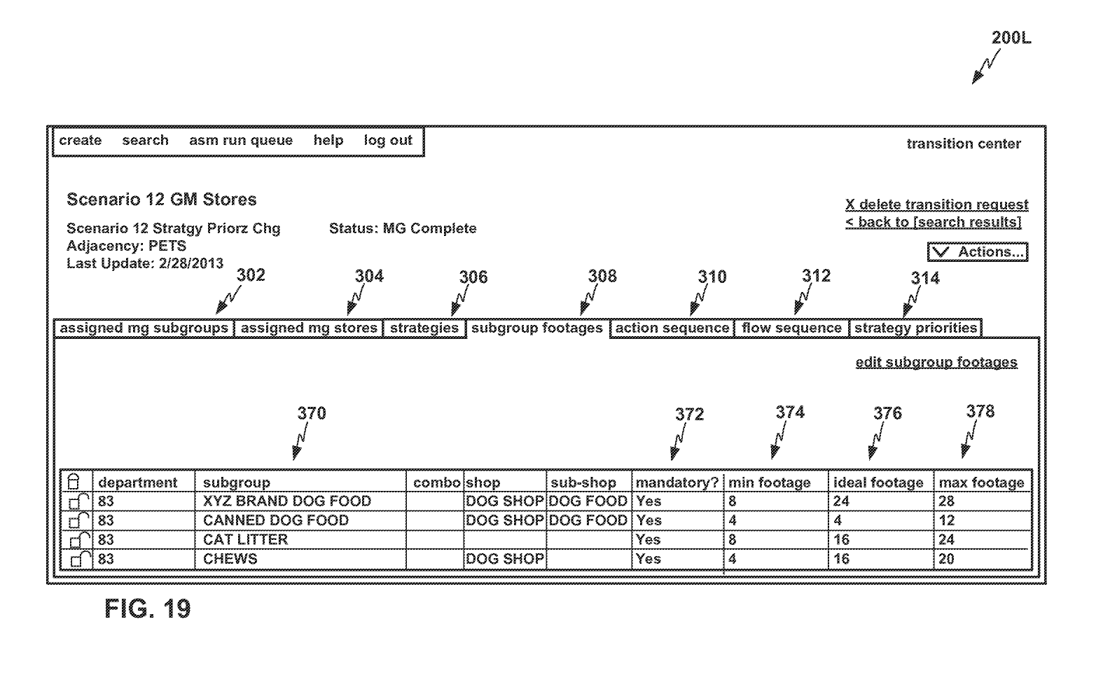

FIG. 19 is a graphical output of an aspect of a user interface 200L for a subgroup footage defining function of a merchandising grid (MG) module 36 of an adjacency mapping system 10 in accordance with aspects of this disclosure. In user interface 200L, subgroup footage tab 308 has been selected, which renders a list of subgroups 370 along with various flexible options for the user to assign criteria for how much footage to assign to each subgroup. In particular, for each subgroup, the user may enter a minimum footage 374, an ideal footage 376, and a maximum footage 378, for example. User interface 200L may also include a mandatoriness option 372 for each subgroup to indicate whether its inclusion is mandatory or not. Various subgroups may also have non-user-editable mapping criteria, such as criteria for a certain subgroup to have mandatory inclusion or a certain minimum footage.

While the user-editable mapping criteria addressed in user interface 200L are discussed above in terms of “footage”, this is merely one example of how merchandising area may be measured, and various other measures of area may also be used in various embodiments.

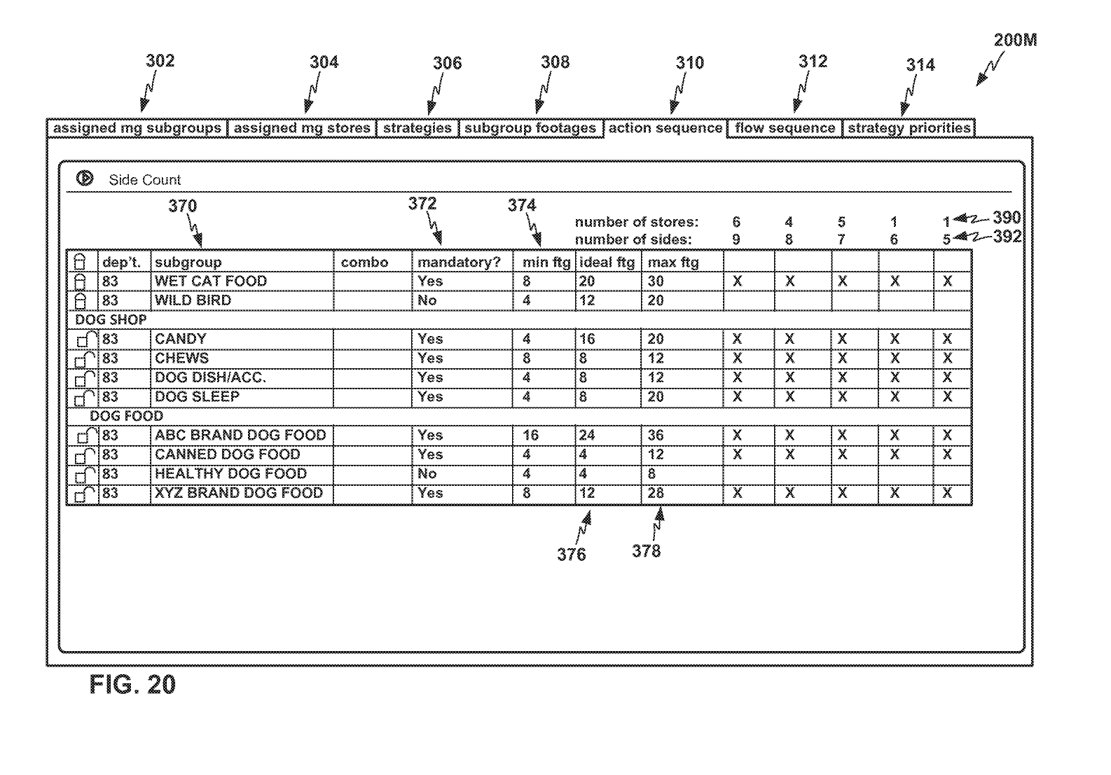

FIG. 20 is a graphical output of an aspect of a user interface 200M for an action sequence defining function of a merchandising grid (MG) module 36 of an adjacency mapping system 10 in accordance with aspects of this disclosure. In user interface 200M, action sequence tab 310 has been selected. User interface 200M still renders the list of subgroups 370 and other columns from user interface 200L of FIG. 19, along with a number of stores row 390 and a number of sides row 392 that indicate how many of the selected stores have how much merchandising space, in terms of gondola sides or wall sides, are devoted to the “Pets” adjacency. In particular, owing to the range of sizes and store layouts of the various selected stores, rows 390 and 392 indicate that there are 6 stores with 9 sides in the “Pets” adjacency, 4 stores with 8 sides in this adjacency, 5 stores with 7 sides in this adjacency, 1 store with only 6 sides in this adjacency, and 1 store with only 5 sides in this adjacency.

The action sequence columns beneath these rows 390 and 392 may be used to enter user inputs for an action sequence for determining which non-mandatory subgroups in the “Pets” adjacency to assign to groups of stores, based on the user-editable mapping criteria and on the number of sides or other count of the footage assigned to the “Pets” adjacency for each group of stores. Subgroups listed as mandatory in column 372 are automatically assigned to all stores, and for these subgroups, the action sequence column entries are each populated with an “X” showing that they are not open to enter inputs. For subgroups listed as non-mandatory in column 372, the action sequence columns under rows 390 and 392 are open for the user to enter inputs to define an action sequence that will be used to determine, for each group of stores by number of sides, which of the non-mandatory subgroups will be assigned to that group of stores. For example, for a non-mandatory subgroup that the user prioritizes highly, the user may select this subgroup to be first in the action sequence of assigning non-mandatory subgroups, while if another subgroup is relatively low priority, the user may enter a later count for this subgroup in the action sequence. The merchandising grid (MG) module 36 will assign the non-mandatory subgroups to each set of stores in the order entered for the action sequence. Stores with high numbers of sides assigned to the “Pets” adjacency may be assigned many or all of the non-mandatory subgroups, while stores with low numbers of sides assigned to the “Pets” adjacency may be assigned relatively few of the non-mandatory subgroups. The user-entered inputs for the action sequence thereby serve as further user-editable mapping criteria for mapping the product subgroups in the product adjacency group for each group of stores.

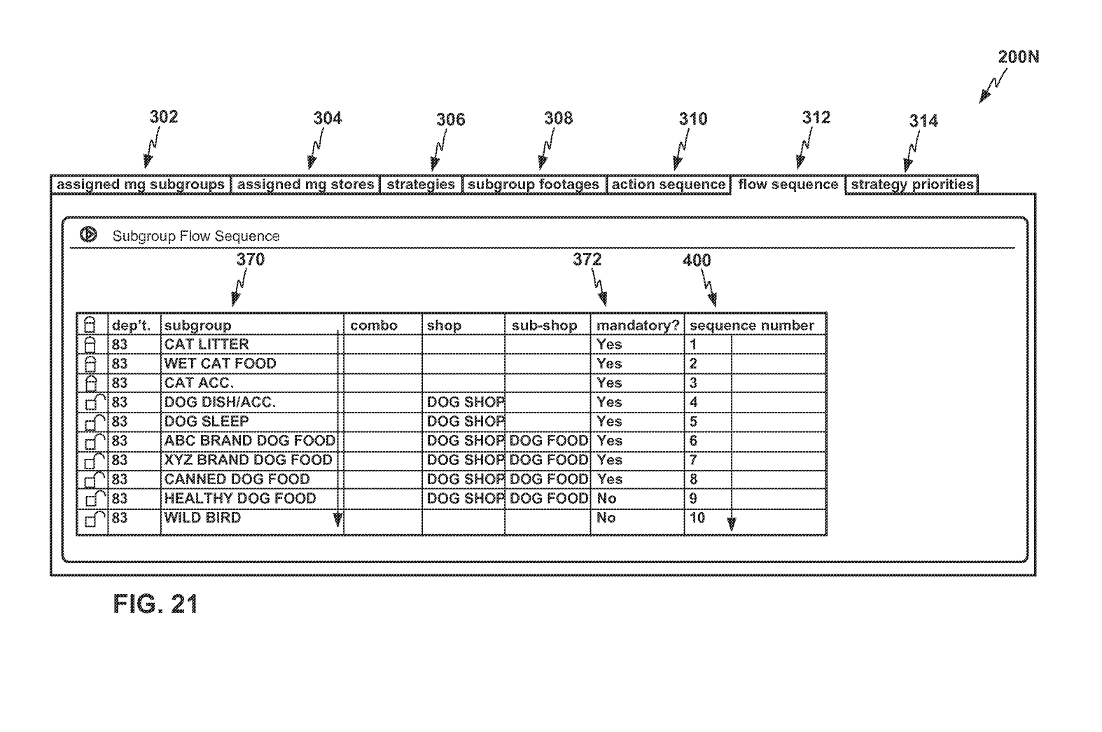

FIG. 21 is a graphical output of an aspect of a user interface 200N for a flow sequence defining function of a merchandising grid (MG) module 36 of an adjacency mapping system 10 in accordance with aspects of this disclosure. User interface 200N shows the flow sequence tab 312 of the merchandising grid module 36 selected. User interface 200N is configured to receive user inputs defining a flow sequence for processing each of the subgroups according to the applicable mapping criteria. Subgroups are listed in subgroup column 370, with each subgroup's row intersecting with mandatoriness column 372 that indicates whether the criteria for that subgroup are mandatory, and sequence number column 400 indicating the sequence in which the subgroups 370 are to be processed in the automated subgroup mapping process.

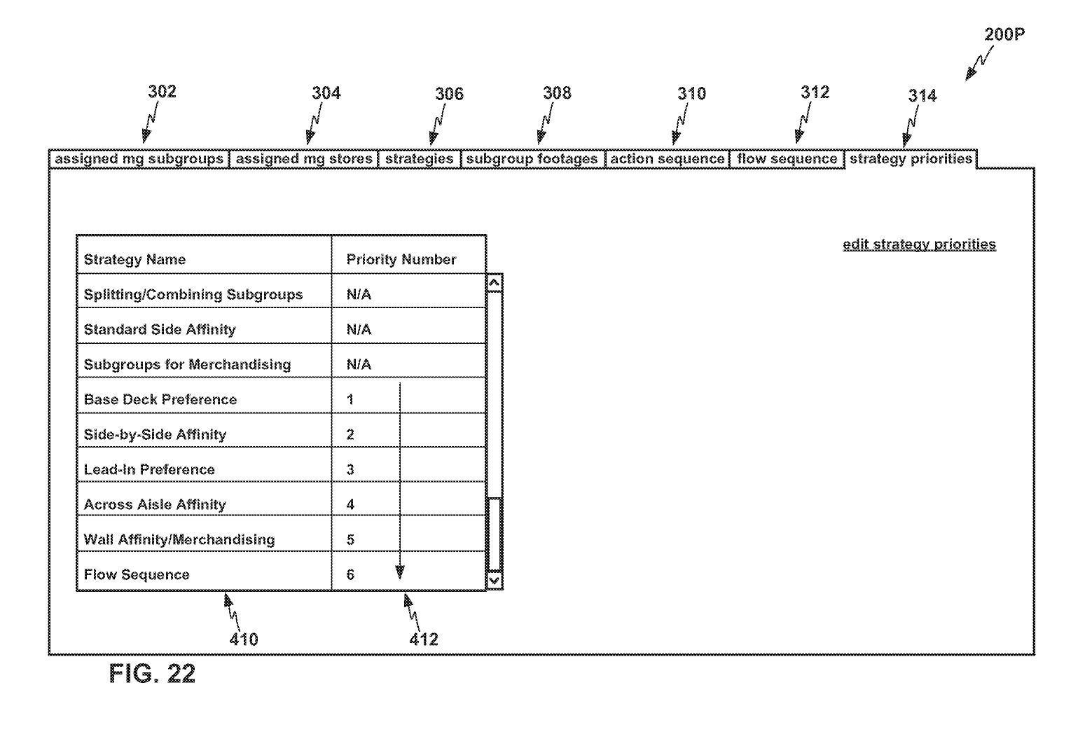

FIG. 22 is a graphical output of an aspect of a user interface 200P for a strategy priority assignment function of a merchandising grid (MG) module 36 of an adjacency mapping system 10 in accordance with aspects of this disclosure. User interface 200P shows the strategy priorities tab 314 of the merchandising grid module 36 selected. User interface 200P is configured to receive user inputs defining a ranking of priorities, as listed in priority number column 412, for applying to different strategies as listed in strategies column 410.

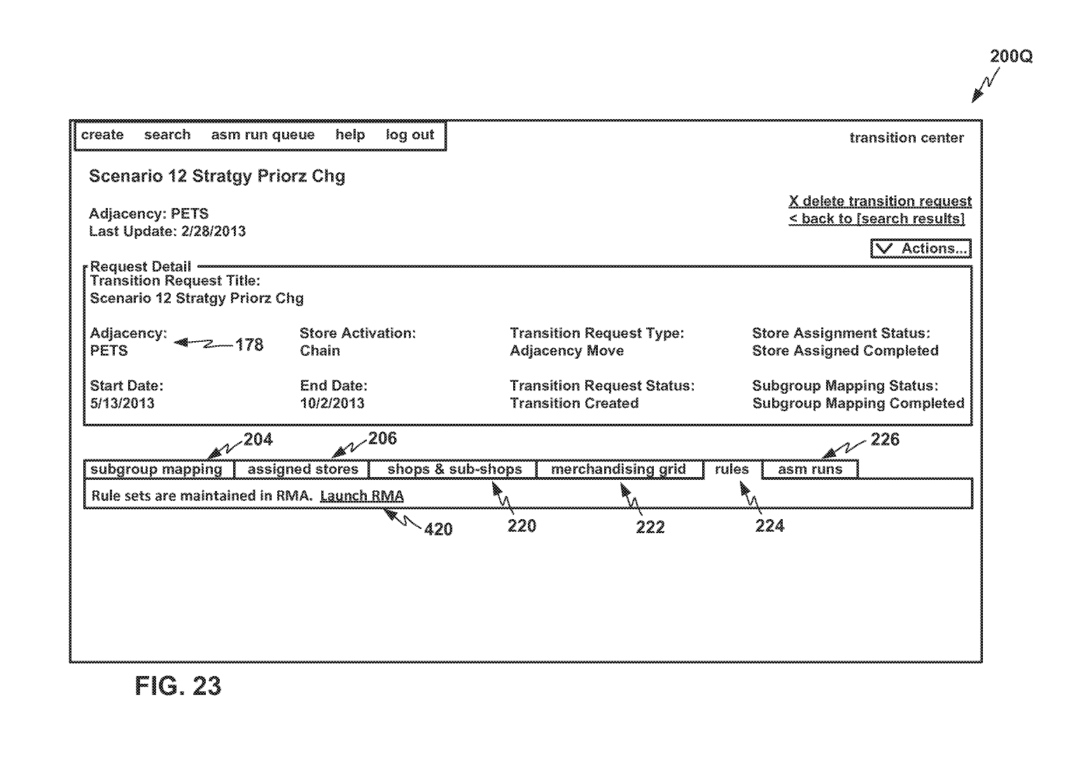

FIG. 23 is a graphical output of an aspect of a user interface 200Q for activating a rules maintenance application (RMA) module 44 of an adjacency mapping system 10 in accordance with aspects of this disclosure. User interface 200Q shows a user interface state with the same tabs as in the transition center user interface as depicted in FIGS. 11, 12, and 14, but now after the user has finished using the merchandising grid. User interface 200Q shows rules tab 224 selected, and an indication that “rule sets are maintained in RMA”, i.e. rules maintenance application (RMA) module 44. RMA module 44 may include both the user-editable subgroup mapping criteria entered in the user interfaces described above, as well as non-user-editable subgroup mapping criteria, for example. User interface 200Q also includes a UI element 420 configured to enable a user to launch or run the RMA module 44.

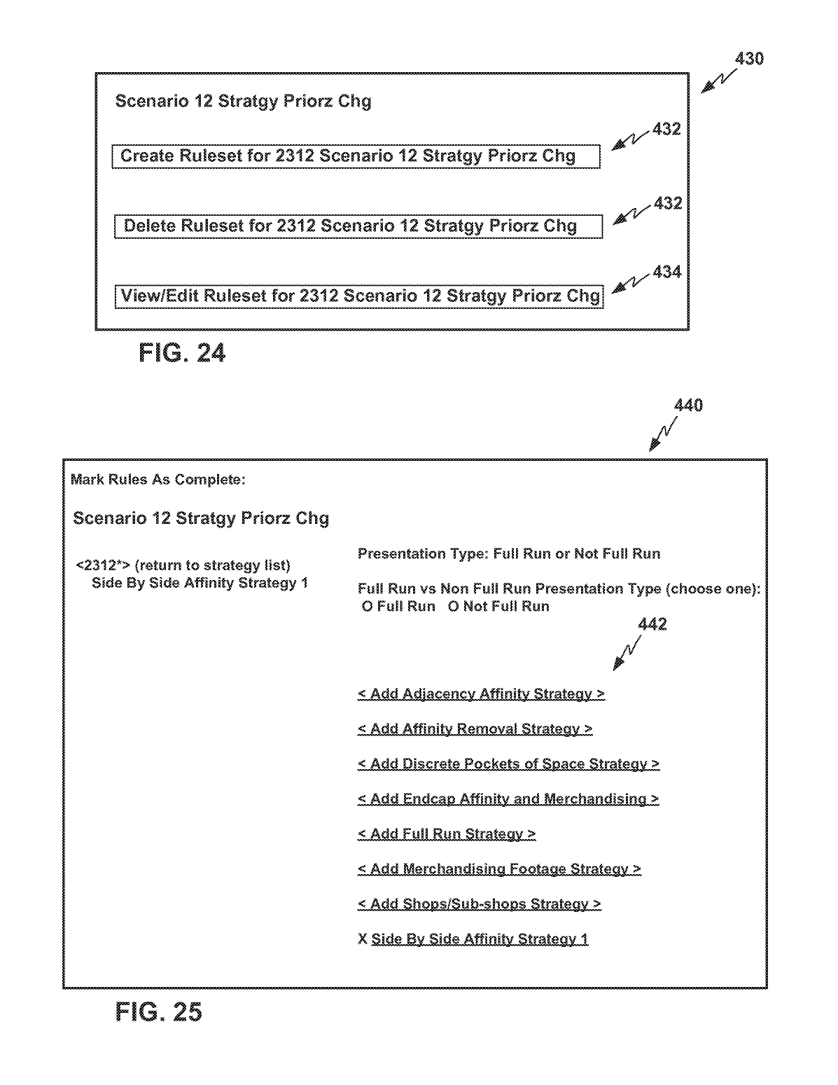

FIG. 24 is a graphical output of an aspect of a user interface 430 for a rule set creation function in a rules maintenance application (RMA) module 44 of an adjacency mapping system 10 in accordance with aspects of this disclosure. User interface 430 may be presented when a user creates a transition and launches the RMA module 44. User interface 430 includes a “create rule-set” button 431 to create a set of rules, a “delete rule-set” button 432 to delete a selected set of rules, and a “view/edit ruleset” button 434 to view or edit a selected set of rules.

FIG. 25 is a graphical output of an aspect of a user interface 440 for a strategy selection function of a rules maintenance application (RMA) module 44 of an adjacency mapping system 10 in accordance with aspects of this disclosure. User interface 440 includes user-selectable options for viewing, editing, adding, or deleting various strategies for an automated adjacency mapping process.

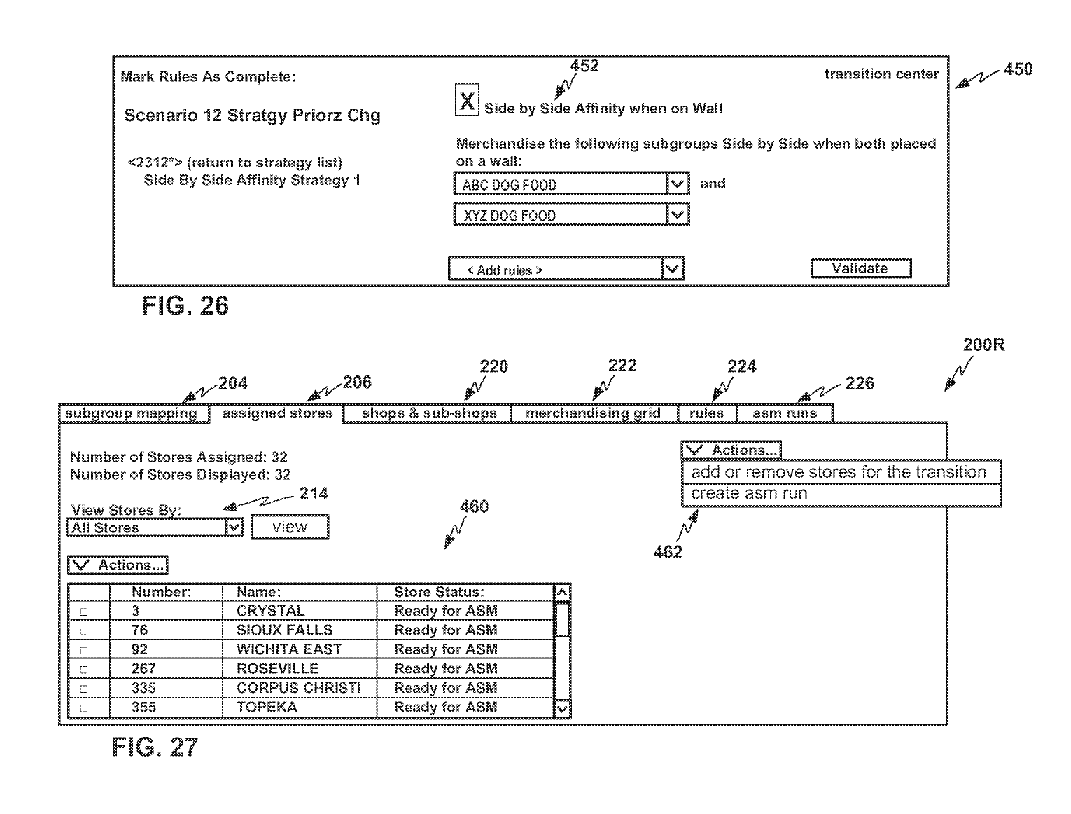

FIG. 26 is a graphical output of an aspect of a user interface 450 for a rule creation function in a rules maintenance application (RMA) module 44 of an adjacency mapping system 10 in accordance with aspects of this disclosure. User interface 450 includes a UI element configured to enable user inputs for defining strategy exception rules, i.e., rules that serve as exceptions to selected strategies.

FIG. 27 is a graphical output of an aspect of a user interface 200R for creating an automated store merchandising (ASM) run in an ASM module 30 of an adjacency mapping system 10 in accordance with aspects of this disclosure. User interface 200R once again has assigned stores tab 206 selected and shows in column 460 that each of the listed stores has a store status of “ready for automated store merchandising (ASM)”. User interface 200R also includes action menu 462 with options to add or remove stores for this transition, or to create an automated store merchandising (ASM) run.

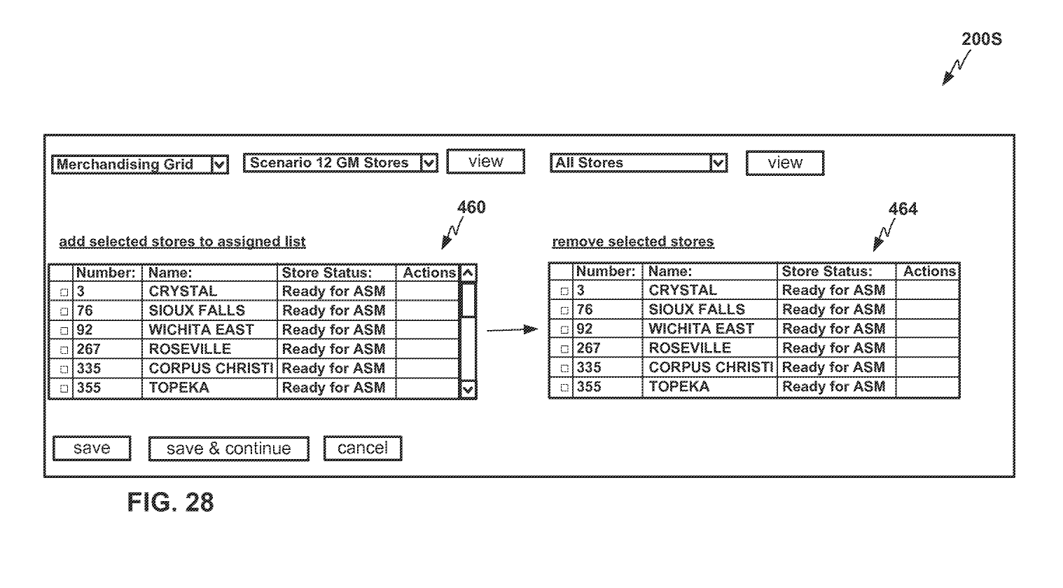

FIG. 28 is a graphical output of an aspect of a user interface 200S for a store selection function in an automated store merchandising (ASM) module 30 of an adjacency mapping system 10 in accordance with aspects of this disclosure, with automated store merchandising (ASM) module 30 running, and generating a combined set of mapping criteria for the user-selected product subgroups based on the user inputs for each of the user-editable mapping criteria and non-user-editable mapping criteria. The ASM run may process an automated adjacency mapping to generate a subgroup mapping for each of the selected stores in sequence, with the selected stores in list 460 being added to ASM run list 464 as ASM module 30 processes each store, and as the user saves or submits each ASM run. ASM module 30 may generate a subgroup mapping for the selected adjacency that serves as a merchandising solution combining user-edited or user-defined rules entered for each of merchandising grid (MG) module 36, rules maintenance application (RMA) module 44, and visual merchandising tool (VMT) module 40, as well as any applicable non-user-editable rules, for each of the selected stores.

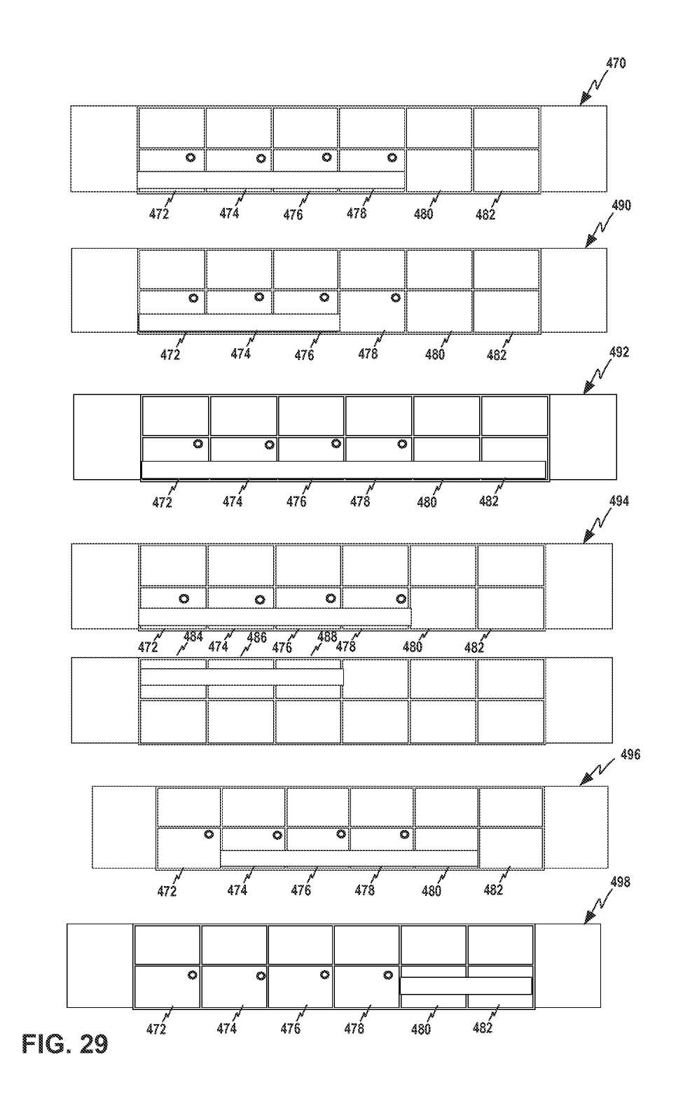

FIG. 29 is a graphical output of aspects of persistence logic for an automated store merchandising (ASM) module 30 of an adjacency mapping system 10 in accordance with aspects of this disclosure. FIG. 29 depicts an example of rules that rules maintenance application (RMA) module 44 may apply, and in particular a “persistence criterion”, as part of the processing of ASM module 30 to generate the product subgroup maps.

The non-user-editable mapping criteria may include “hard constraints”, or mandatory rules to observe in mapping the subgroups. For example, the mandatory rules may include a rule that all sections must be assigned to one and only one subgroup, and a rule that each subgroup must be assigned to at least one section. Another mandatory rule may be that each subgroup must be assigned between the minimum and maximum area defined by the user inputs.

The non-user-editable mapping criteria may also include priority rules, or weighted rules that are not mandatory but that each carry a priority weighting, which automated store merchandising (ASM) module 40 may evaluate relative to priority weightings of all other applicable mapping criteria, including both non-user-editable mapping criteria and user-editable mapping criteria edited according to the user inputs, in generating a product subgroup map.

One non-user-editable mapping criterion may be a persistence criterion that places a relatively high priority on persisting product subgroup mapping positions from a previous product subgroup map for a product adjacency group. FIG. 29 helps illustrate this persistence criterion. Gondola 470 shows the state of a gondola in a pre-existing subgroup mapping, with one subgroup occupying four contiguous planogram sections 472, 474, 476, 478 along one side of the gondola. The other gondola scenarios depicted in FIG. 29 show a representative sample of possible states that this subgroup may be mapped to in the transition, and how they relate to the original position of this subgroup in the pre-existing subgroup mapping.

Gondola 490 shows the subgroup mapped to a smaller area, of planogram sections 472, 474, and 476, but that all occupy planogram sections that were occupied by the subgroup in gondola 470. Gondola 492 shows the subgroup mapped to a larger area, of planogram sections 472, 474, 476, 478, 480, 482, where this larger area includes all the planogram sections that this subgroup occupied in the pre-existing subgroup map. Gondola 494 also shows the shows the subgroup mapped to a larger area, of planogram sections 472, 474, 476, 478, as well as sections 484, 486, 488 on another gondola side opposite an aisle from the original gondola side. In another possible subgroup mapping, the subgroup could be unchanged in size and remain in the same four planogram sections as in gondola 470.

In each of these options, the persistence criterion would be valued at a 100% persistence rating. The rules for the persistence criterion recognize that a subgroup may often be mapped to a smaller or larger total area, but the persistence criterion does not penalize this. Instead, the persistence criterion gives its highest rating, i.e. a 100% rating, to a mapping option that involves the minimum possible relocation of sections (i.e. planogram sections) given any changes in total area. If the total area devoted to a subgroup in a new mapping is smaller or larger than the pre-existing area, then keeping the subgroup in at least the same sections as much as possible qualifies for as much persistence as is available given the expansion or reduction in area devoted to that subgroup.

Gondola 496 shows another option in which the subgroup is mapped to sections 474, 476, 478, 480. In this option, the subgroup is mapped out of one pre-existing section, section 472, and mapped into one new section, section 480. This option therefore involves a violation of persistence, in that some of the subgroup is mapped to a new section without being necessitated by an expansion in its area. This option still has partial persistence though, in that three of the sections for this subgroup are left alone. This option is therefore given a partial score for its persistence value according to the persistence criterion. This partial score may be calculated as the percentage of merchandising sections or area that are persisted without the lack of persistence being necessitated by a change in area, i.e. a score of 75% in this case.

In the example of gondola 498, there is no actual persistence of any planogram sections, although at least the subgroup has been remapped to planogram sections in the same aisle as their previous position. Since this represents a relatively minor product movement relative to moving to a completely different aisle, a persistence criterion may still count this repositioning as having a relatively low but non-zero persistence score, such as 10%, for example. If a mapping option would have a subgroup remapped to a completely different aisle, this would be awarded a very low persistence value, such as 0%.

In various examples, the ASM module 30 may apply the mapping criteria in a hierarchy. For example, ASM module 30 may determine the area, in terms of footage, to assign to each of the product subgroups, as the first priority, and apply the persistence criterion in how the subgroups are positioned as the second priority, and then apply all other criteria as tertiary priorities. In this example, even when the footage is changed for various product subgroups, the ASM module 30 ensures that the amount of movement of products is relatively minimal within the demands of the changes in footage for various subgroups. The system may also provide user options for pro-persistence mapping overrides, such as an option to override subgroup mapping to carry forward or override subgroup mapping to basic reset, each of which may be applied to any one or more product subgroups and to any one or more stores. Subgroups selected for a carry forward are omitted from subgroup remapping and are instead persisted from their previous mapping to the new mapping, in the selected stores. Subgroups selected for a basic reset are similarly omitted from subgroup remapping and instead persisted from their previous mapping to the new mapping, but are left enabled for initiating a new planogram within an individual subgroup, so that particular products as charted in a planogram within the subgroup may be re-mapped, while the subgroup itself has no change in mapping.

The persistence criterion thus incorporates a recognition of the added burden involved in mapping portions of an existing product subgroup out of one or more planogram sections and into new planogram sections, which would induce added labor and added logistical complexity in the form of removing lots of products from merchandising fixtures in one place and moving those products over to new positions. Given the many relevant criteria and constraints to balance in mapping subgroups according to new adjacency mapping criteria, it can be surprisingly common for the same subgroup to be mapped from one or more planogram sections to one or more new planogram sections, and surprisingly difficult to avoid a proliferation of shifting products around from one position to another when subgroups are mapped according to a variety of other mapping criteria in what is meant to be a balanced set of mapping criteria.

Implementing a persistence criterion with a high priority therefore incorporates the insight that avoiding unnecessary shifting of products from one position to another has a high importance respective to product subgroup mapping criteria overall. A potential subgroup mapping that may be optimized or ideal if starting from scratch may not provide enough benefit to outweigh the burden of shifting products around when given the initial conditions of the pre-existing subgroup map. Remapping product subgroups, especially to a completely different aisle, may also confuse consumers and deter them from being able to find what they are looking for, and may therefore erode potential sales. While sales data such as affinities and preferences may support a forecast that a particular new subgroup map may drive a certain minor percentage of higher sales for certain subgroups, when all factors are considered, the forecasted benefit of these affinities may be relatively minor compared with the real total cost in terms of added labor, logistical burden, operational interference, and consumer confusion involved in high levels of shifting products from one position to another.

The high-priority persistence criterion of this disclosure incorporates the real total cost of added labor, logistical burden, operational interference, and consumer confusion of shifting products around among nearby merchandising fixtures within an adjacency, and incorporates this true cost in the total balancing of applicable criteria in subgroup mapping. This high-priority persistence criterion tends to influence product subgroup mapping to be more conservative in re-positioning products and tends to generate relatively minor shifts in product subgroup maps when they are remapped according to new criteria.

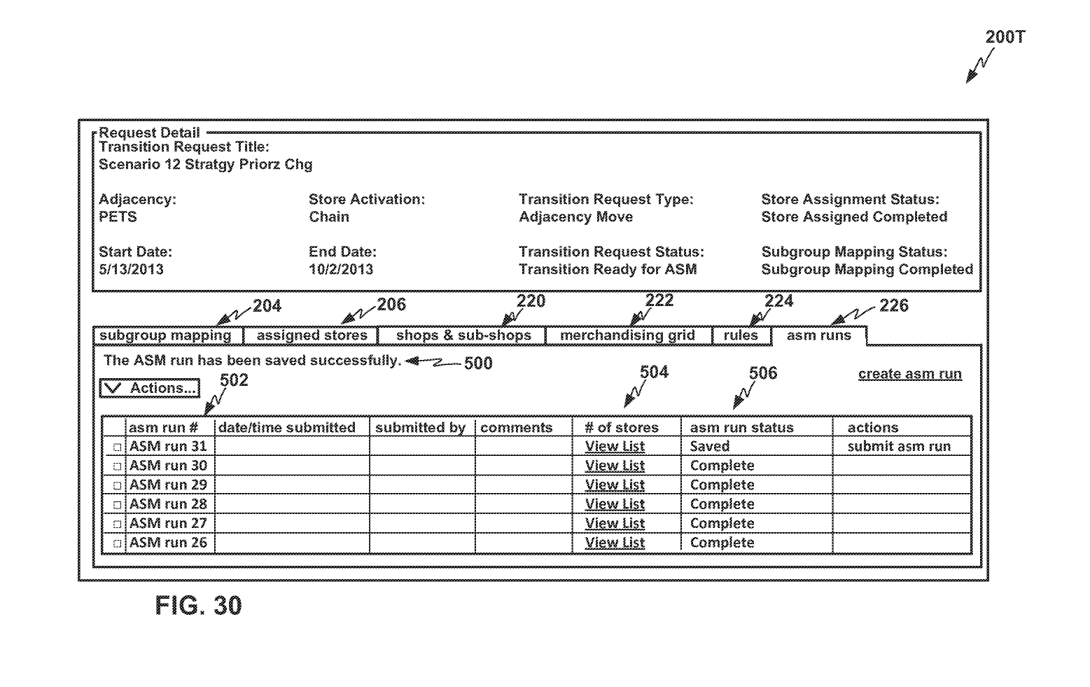

FIG. 30 is a graphical output of an aspect of a user interface 200T for automated store merchandising (ASM) runs in an ASM module 30 of an adjacency mapping system 10 in accordance with aspects of this disclosure. User interface 200T indicates at UI element 500 that the ASM run was saved successfully. User interface 200T includes a list of saved or submitted ASM runs 502, along with selectable options to view the ASM runs in column 504 and a status column 506. Status column 506 indicates ASM runs as saved or complete, in which runs that have already been submitted and completed are listed as complete. Submitting a saved ASM run may enable a user to access a graphical output of a product subgroup mapping generated by the ASM run, once the ASM run is complete.

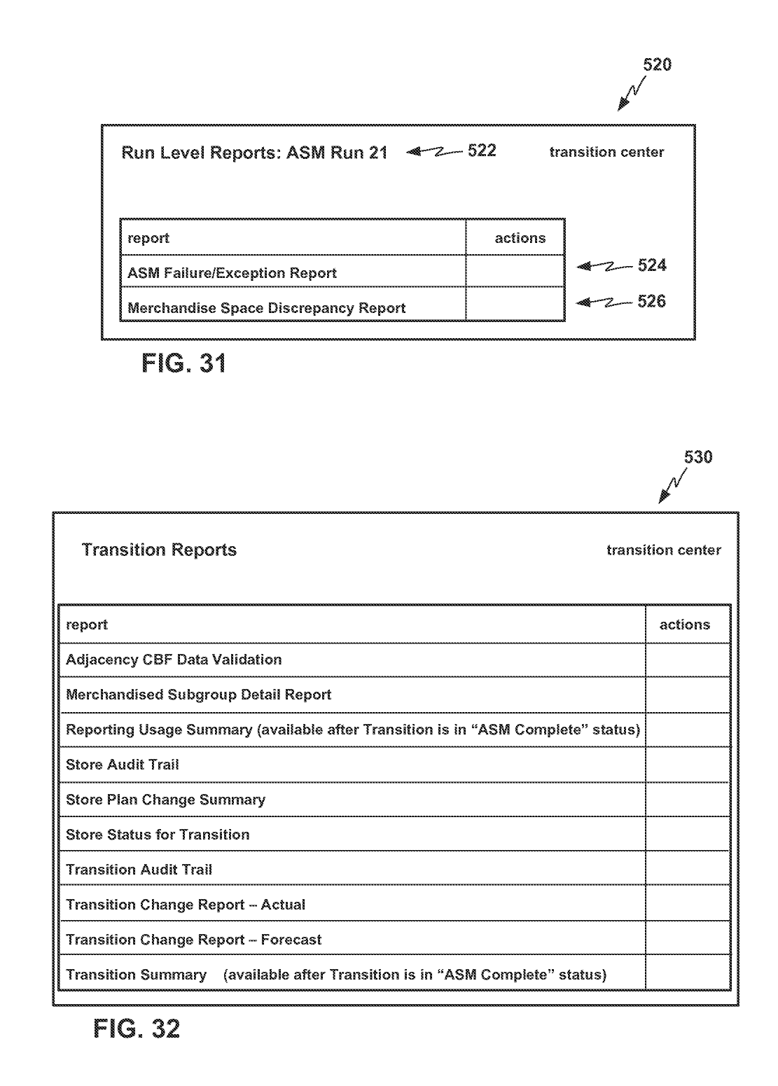

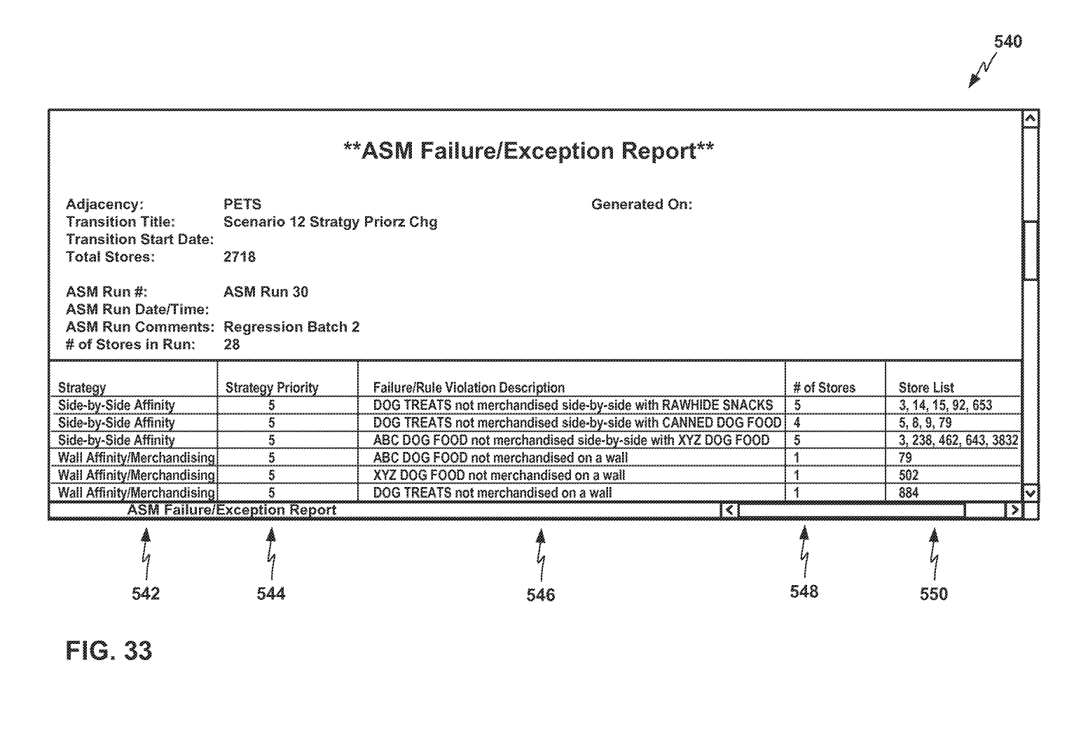

FIG. 31 is a graphical output of an aspect of a user interface 520 for a reporting feature for an automated store merchandising (ASM) module 30 of an adjacency mapping system 10 in accordance with aspects of this disclosure. User interface 520 includes an ASM run report title 522, and is configured for user-selectable access to various types of transition reporting including an ASM Failure/Exception Report 524 and a Merchandise Space Discrepancy report 526. Since an ASM run may include a large number of conflicting mapping criteria, it may be impossible to satisfy all the criteria, and the ASM run may optimize among the various mapping criteria and their priorities, to generate as few exceptions as possible and with as low priority levels as possible. For example, the ASM module 30 may assign positive or negative numerical weights to each of the mapping criteria, and run the criteria through an optimization process, such as a linear regression model or other statistical technique, that maximizes a total value for all of the weights, or that minimizes a total penalty for all of the weights, for example. Then, if a user selects the ASM Failure/Exception Report 524, this report will show what rules or other subgroup mapping criteria were violated in the subgroup mapping, as further detailed in FIG. 33.

FIG. 32 is a graphical output of an aspect of a user interface 530 for a transition reporting feature for an adjacency mapping system 10 in accordance with aspects of this disclosure. User interface 530 may provide user-selectable access to any of a number of additional types of transition reporting with information on transitions. As shown in FIG. 32, these available reports include an Adjacency CBF Data Validation Report, a Merchandised Subgroup Detail Report, a Reporting Usage Summary, a Store Audit Trail, a Store Plan Change Summary, a Store Status for Transition Report, a Transition Audit Trail, a Transition Change Report—Actual, a Transition Change Report—Forecast, and a Transition Summary Report, in this example.

FIG. 33 is a graphical output of an aspect of a user interface 540 for a reporting feature for an automated store merchandising (ASM) module 30 of an adjacency mapping system 10 in accordance with aspects of this disclosure. When a user selects an ASM failure/exception report 524 from among the transition reporting options in user interface 520 as shown in FIG. 31, the adjacency mapping system 10 may respond by providing user interface 540 which displays and describes failures or exceptions to rules or other subgroup mapping criteria. User interface 540 shows a strategy column 542, a priority column 544 showing the priority assigned to each strategy, a description column 546 showing a description of the rule violation, column 548 that shows the number of stores having violations of their mapping, rules, or strategy criteria, and store list column 550 showing indications of which specific stores are affected.

It may be the case that exceptions commonly involve a minority of stores with non-standard or unique store layouts, where the store layouts don't lend themselves as well to regular treatment by the subgroup mapping process. For example, a store built in a legacy retail space may include a high number of fixtures with measurements or dimensions that don't conform to standardized fixture dimensions used in the enterprise's standardized store layouts. As a specific example, the standardized layouts may be built around four-foot-wide planogram sections, with all wall and gondola space being built to accommodate multiples of four-foot planogram sections, while the legacy retail space may occupy an older building with doors, support beams, and other permanent architectural structures that pose a high number of breaks in the merchandising space that result in a high number of exceptions to four-foot-wide planogram sections.

User interface 540 generally enables a user to see what subgroup mapping criteria were violated and why, i.e., what other subgroup mapping, rules, or strategy criteria were found to be prioritized higher overall in the weighted balancing of all the criteria. A user may consider this information in potentially entering manual overrides of subgroup maps in some cases, if the user decides a manual subgroup mapping might be preferable to the automatically generated subgroup mapping.

User interface 540 for an ASM failure/exception report may therefore, for each of the failures or exceptions to the subgroup mapping criteria, display a strategy to which that subgroup mapping criterion belongs, in strategy column 542, and a strategy priority of each of the strategies, in priority column 544. User interface 540 for an ASM failure/exception report may also, for each of the failures or exceptions to the subgroup mapping criteria, display a number of stores to which the failure or exception is applicable, in column 548, and a list of the particular stores to which the failure or exception is applicable, in column 550.

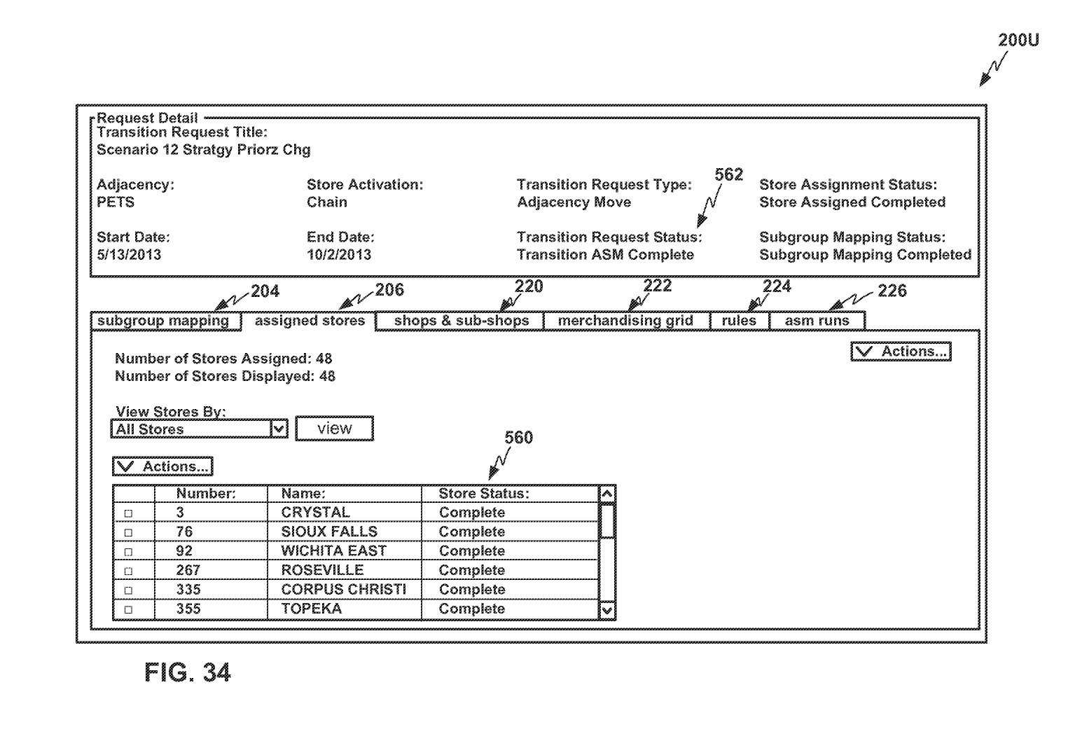

FIG. 34 is a graphical output of an aspect of a user interface 200U for a store status function of a transition center (TC) module 32 of adjacency mapping system 10 in accordance with aspects of this disclosure. User interface 200U shows UI element 562 indicating that a transition has all stores in complete status. Column 560 shows the store statuses as complete, potentially including all of the selected stores.

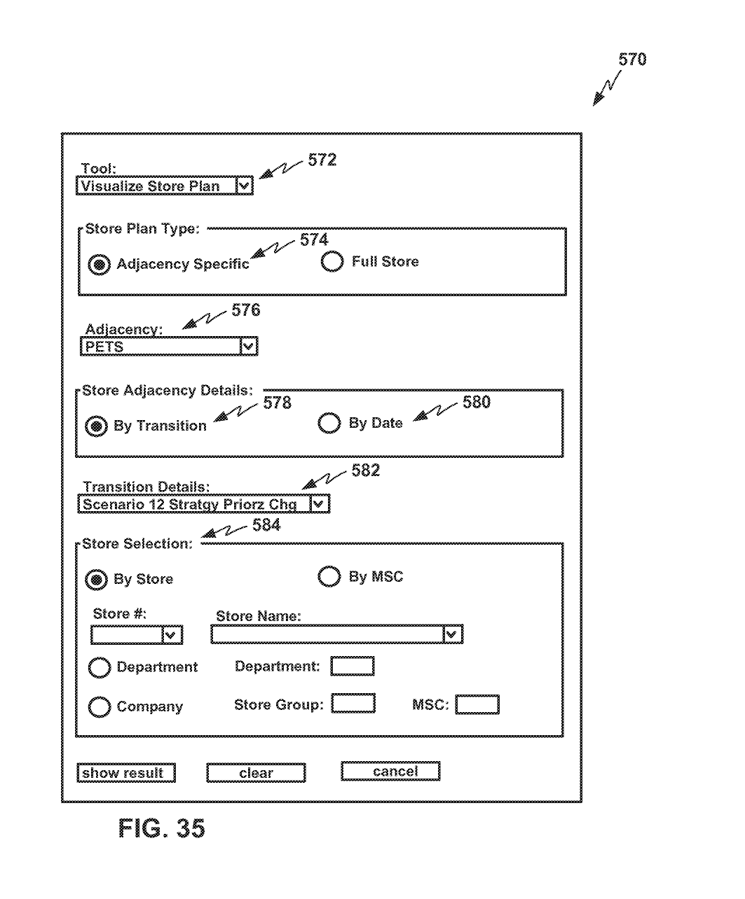

FIG. 35 is a graphical output of an aspect of a user interface 570 for a search function with a visual merchandising tool (VMT) module 40 of adjacency mapping system 10 in accordance with aspects of this disclosure. User interface 570 may include a user-selectable option to “visualize store plan” for the affected adjacency, i.e., to have the visual merchandising tool (VMT) module 40 of the adjacency mapping system 10 provide a graphical output of the product subgroup map for the product adjacency group. User-selectable option 574 may be used to request the product subgroup map for the product adjacency group, while another option is provided to request the product subgroup maps in effect for a full store. User interface 570 includes adjacency selection field, which is selected for the “Pets” adjacency. Option 578 is for selecting the graphical output specific to a transition. Selectable field 582 may be used to select a specific transition, by the title it is saved under. Option 584 may be used to select a specific store.

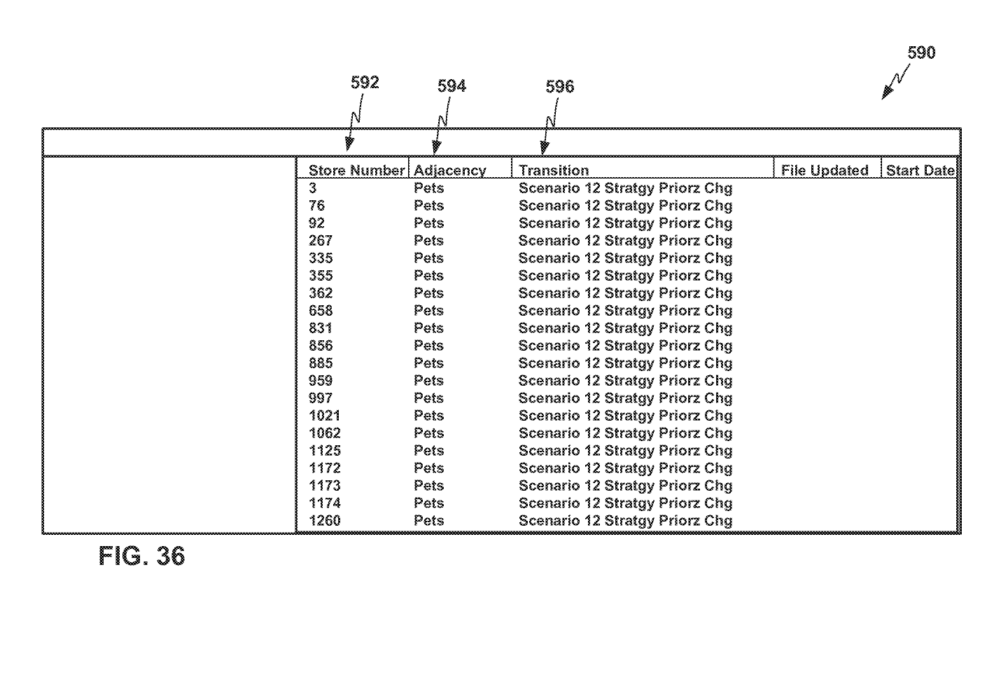

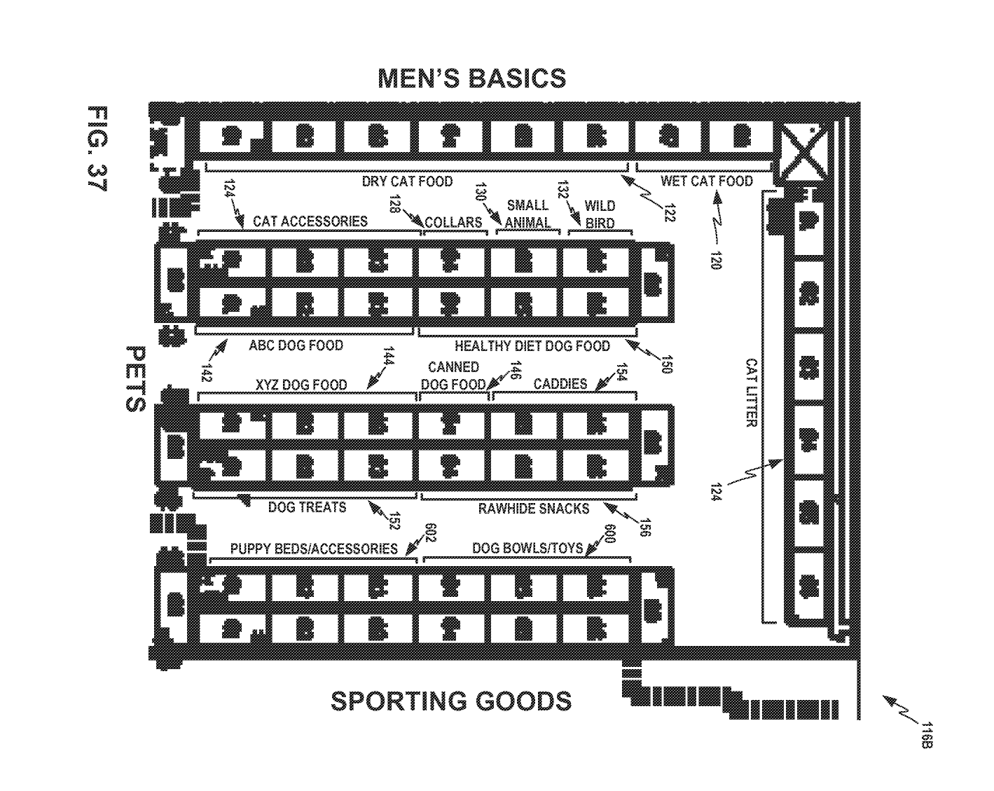

FIG. 36 is a graphical output of an aspect of a user interface 590 for search results with a visual merchandising tool (VMT) module 40 of adjacency mapping system 10 in accordance with aspects of this disclosure. User interface 590 shows a list of the product subgroup maps generated in the transition, for the “Pets” product adjacency group in each of the selected stores. The store numbers are listed in column 592, while column 594 indicates the adjacency as “Pets” in each case, and the column 596 indicates the selected transition in each case.

FIG. 37 is a graphical output of a product subgroup map 116B for an automatically merchandised product adjacency group within the store layout of a store, that may be provided in a user interface for a visual merchandising tool (VMT) module 40 of an adjacency mapping system in accordance with aspects of this disclosure. The newly generated product subgroup map 116B may be compared with the pre-existing product subgroup map 116 depicted in FIG. 7. As FIG. 37 shows, rapidly increasing demand for healthy diet dog food were incorporated in a high priority for additional shelf space for healthy diet dog food, which resulted in an expansion of the healthy diet dog food product subgroup 150 from one planogram section to three planogram sections, in this illustrative example. This change may be driven by strong signals from sales and marketing data, so a high priority was well justified. This expansion necessitated some degree of reorganization and contraction among other subgroups. There may also be high priorities assigned to keeping each subgroup contiguous instead of splitting them up across aisles or gondolas or into other non-contiguous arrangements. This strategy, combined with the three-fold expansion of healthy diet dog food product subgroup 150, provided additional impetus for reorganization, to accommodate a contiguous space for healthy diet dog food product subgroup 150.

Some subgroups were reorganized in the products assigned to them, such that the former “dog bowls and accessories” subgroup 140, “puppy beds” subgroup 148, and “dog toys” subgroup 158 were reorganized into two new subgroups, “dog bowls and toys” subgroup 600 and “puppy beds and accessories” subgroup 602. Internal subgroup reorganization, of the products assigned to a particular subgroup, may be allowed or disallowed, and may be done according to automated rules following different levels of hierarchical relatedness, or manually.

A high priority was also assigned to expanding the rawhide snack subgroup 156, motivated by sales and marketing data that also showed increasing demand for this subgroup, and which resulted in rawhide snack subgroup receiving an increased allotment of three planogram sections from two, in this example. Dog treats subgroup 152 and rawhide snacks subgroup 156 had a high-priority side-by-side affinity, which resulted in these two subgroups being positioned side-by-side on one gondola side, and a similar high-priority side-by-side affinity resulted in the dog bowls and toys subgroup 600 and the puppy beds and accessories subgroup 602 being positioned side-by-side.

A high priority persistence criterion resulted in some cases of subgroups persisting in the same sections, at least as much as possible given changes in total space allotted to them. Dog treats subgroup 152 remained persistent in its three sections, and this combined with its high priority side by side affinity for the rawhide snacks subgroup 156 to result in rawhide snacks being repositioned next to dog treats subgroup 152. ABC brand dog food subgroup 142 and XYZ brand dog food subgroup 144 were both remapped to reduced areas, bearing the reduction needed to expand the healthy diet dog food subgroup 150 and the rawhide snacks subgroup 156, but ABC brand dog food subgroup 142 and XYZ brand dog food subgroup 144 were both remapped to reduced areas entirely overlapping their previous areas. This option was rated at a 100% score for the persistence criterion, and so was a highly favored option.

On the other hand, a strong priority was also placed on a side-by-side affinity of canned dog food subgroup 146 with any other dog food sub-shop subgroup, and this rule, combined with all the other factors being balanced together in the remapping of the “Pets” adjacency, resulted in the canned dog food subgroup 146 being entirely relocated from its previous position to a new position adjacent XYZ brand dog food subgroup 144. However, since the new position for canned dog food subgroup 146 is still in the same aisle as its previous position, it still received a low but non-zero score on the persistence criterion, which helped enable this move, whereas a move to an entirely different aisle and a persistence rating of 0% might not have been possible in the total factor balancing performed by automated adjacency mapping system 10.

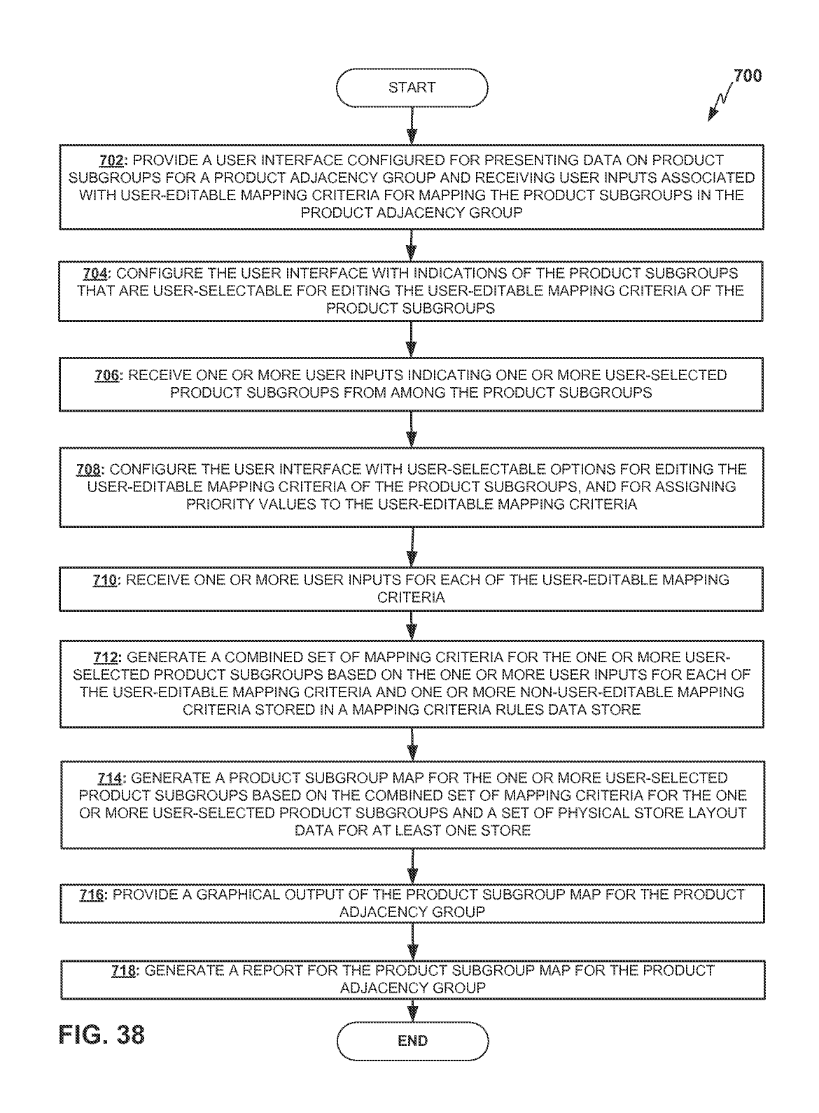

FIG. 38: Example Method of Operation

FIG. 38 is a flowchart illustrating an example method of operation 700 of an adjacency mapping system of this disclosure, such as adjacency mapping system 10 of FIG. 1 and the various aspects depicted in and described with reference to FIGS. 2-37. By performing method 700, elements of an adjacency mapping system may generate a product subgroup map for a product adjacency group.

Method 700 may illustratively be discussed in terms of operations or functions performed by a device, such as the various server devices and other computing devices described above. In performing method 700, a device may provide a user interface, such as subgroup mapping transition center user interface 16 of FIGS. 1 and 200A-T of FIGS. 8-34, configured for presenting data on product subgroups for a product adjacency group and receiving user inputs associated with user-editable mapping criteria for mapping the product subgroups in the product adjacency group (702).

The device may provide and configure a user interface by sending data to the user interface from a separate computing device than the computing device that renders the user interface, as in the case of the device being a server device running a web application, for example. The device may also provide and configure a user interface by rendering the user interface, based on data the device either receives from one or more separate computing resources, as in the case of a client computing device accessing a web application, or based on data the device generates itself, potentially with the use of data accessed from other computing resources, as in the case of a computing device running a local application, for example. Thus, in a client-server context running a web application implementation, both the server device and the client device may perform or embody method 700, in addition to a single computing device that may perform or embody method 700 in the context of a computing device running its own local application.

The device may configure the user interface with indications of the product subgroups that are user-selectable for editing the user-editable mapping criteria of the product subgroups (704), such as the subgroup mapping transition center user interface 200A, 200B as depicted in FIGS. 8 and 9. The device may receive one or more user inputs indicating one or more user-selected product subgroups from among the product subgroups (706), as illustratively depicted in FIGS. 8, 9, 12, 13, 14, and 15. The device may configure the user interface with user-selectable options for editing the user-editable mapping criteria of the product subgroups, and for assigning priority values to the user-editable mapping criteria (708), as illustratively depicted in FIGS. 17, 18, 19, 20, 21, and 22. The device may receive one or more user inputs for each of the user-editable mapping criteria (710), as also depicted in the examples of FIGS. 17, 18, 19, 20, 21, and 22.

The device may then generate a combined set of mapping criteria for the one or more user-selected product subgroups based on the one or more user inputs for each of the user-editable mapping criteria and one or more non-user-editable mapping criteria stored in a mapping rules data store, wherein the one or more non-user-editable mapping criteria comprise a persistence criterion that places a high priority on persisting product subgroup mapping positions from a previous product subgroup map for the product subgroup (712). The device may also generate a product subgroup map for the one or more user-selected product subgroups based on the combined set of mapping criteria for the one or more user-selected product subgroups and a set of physical store layout data for at least one store (714). The device may then provide a graphical output of the product subgroup map for the product adjacency group (716), such as product subgroup map 116B for the “Pets” adjacency group in the example depicted in FIG. 37. The device may then generate a report for the product subgroup map for the product adjacency group (718), such as any of the transitioning reporting depicted in and described in connection with FIGS. 31-33, for example.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer implemented process such that the instructions which execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may be executed in a different order, or the functions in different blocks may be processed in different but parallel threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

Aspects of this disclosure may be equally applicable and implemented in any browser or operating system, and using any other APIs, frameworks, or toolsets. Aspects described herein for transmission, decoding, and rendering of data for video output or video content, which may be considered interchangeably herein with media output or media content that also includes audio output or audio content, may make use of any protocol, standard, format, codec, compression format, HTML element, or other technique or scheme for encoding, processing, decoding, rendering, or displaying an audio output or a video output.

Various techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In various examples, an article of manufacture may comprise one or more computer-readable storage media.

In various examples, the data storage devices and/or memory may comprise computer-readable storage media that may comprise non-transitory media. The term “non-transitory” may indicate that the storage medium is not embodied in a carrier wave or a propagated signal. In certain examples, a non-transitory storage medium may store data that can, over time, change (e.g., in RAM or cache). Machine-readable code may be stored on the data storage devices and/or memory, and may include executable instructions that are executable by at least one processor. “Machine-readable code” and “executable instructions” may refer to any form of software code, including machine code, assembly instructions or assembly language, bytecode, software code in C, or software code written in any higher-level programming language that may be compiled or interpreted into executable instructions that may be executable by at least one processor, including software code written in languages that treat code as data to be processed, or that enable code to manipulate or generate code. Various techniques described herein may be implemented in software that may be written in any of a variety of languages, making use of any of a variety of toolsets, frameworks, APIs, programming environments, virtual machines, libraries, and other computing resources, as indicated above. For example, software code for implementing various aspects of this disclosure may be written in Java, C, C++, Python, Ruby, Scala, Clojure, or any other language.

In various examples, a merchandise presentation planning web application may be written in Java and be configured to provide content in JavaScript in the user's browser on a client computing device. For example, the web application may include functionality to generate HTML in Java and JavaScript, and to access JavaScript libraries for supporting DOM and AJAX functions in the browser of the client computing device. In other examples, all or portions of the web application may also be written in Python, Ruby, Clojure, or any other programming language. In other examples, a merchandise presentation planning application may run directly on the client computing device.

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor” as used herein may refer to any of the foregoing structure or any other structure suitable for implementation of the techniques described herein. In addition, in some aspects, functionality described in this disclosure may be provided within software modules or hardware modules.

Various examples have been described. These and other examples are within the scope of the following claims.

What is claimed is:

1. A method for generating a product subgroup map with a computing system, the method comprising:
providing a user interface configured for presenting data on product subgroups for a product adjacency group and receiving user inputs associated with user-editable mapping criteria for mapping the product subgroups in the product adjacency group;
configuring the user interface with indications of the product subgroups that are user-selectable for editing the user-editable mapping criteria of the product subgroups;
receiving one or more user inputs indicating one or more user-selected product subgroups from among the product subgroups;
configuring the user interface with user-selectable options for editing the user-editable mapping criteria of the product subgroups, and for assigning priority values to the user-editable mapping criteria;
receiving one or more user inputs for each of the user-editable mapping criteria;
generating a combined set of mapping criteria for the one or more user-selected product subgroups based on the one or more user inputs for each of the user-editable mapping criteria and one or more non-user-editable mapping criteria stored in a mapping rules data store;
generating a product subgroup map for the one or more user-selected product subgroups based on the combined set of mapping criteria for the one or more user-selected product subgroups and a set of physical store layout data for at least one store;
providing a graphical output of the product subgroup map for the product adjacency group; and
generating a report for the product subgroup map for the product adjacency group.

2. The method of claim 1, wherein generating the report for the product subgroup map comprises:
combining information on the product subgroup map with information on previous product subgroup maps for the product adjacency group.

3. The method of claim 1, wherein generating the report for the product subgroup map comprises:
tracking a number of times a product subgroup map has been generated for the at least one store; and
configuring the user interface to provide indications of the number of times a product subgroup map has been generated for the at least one store

4. The method of claim 1, wherein the at least one store comprises a plurality of stores, the method further comprising:
configuring the user interface with user-selectable indications of a plurality of stores;
generating a plurality of product subgroup maps for the one or more user-selected product subgroups for each of the plurality of store layouts associated with each store of the plurality of the stores as selected by the user inputs, based on the combined set of mapping criteria for the one or more user-selected product subgroups and a set of physical store layout data for each store of the plurality of stores; and
providing a graphical output of the plurality of product subgroup maps for the product adjacency group for each of the plurality of store layouts.

5. The method of claim 4, further comprising:
combining information on the product subgroup map with information on previous product subgroup maps for the product adjacency group;
tracking a number of times a product subgroup map has been generated for each store of the plurality of stores; and
configuring the user interface to provide indications of the number of times a product subgroup map has been generated for each store of the plurality of stores.

6. The method of claim 5, further comprising:
organizing groups of the stores by the number of times a product subgroup map has been generated for each of the plurality of stores.

7. The method of claim 6, further comprising:
displaying the groups of the stores in order by the number of times a product subgroup map has been generated for each of the plurality of stores.

8. The method of claim 1, wherein generating the report for the product subgroup map comprises:
displaying failures or exceptions to one or more of the subgroup mapping criteria.

9. The method of claim 8, further comprising:
for each of the failures or exceptions to the subgroup mapping criteria, displaying a strategy to which that subgroup mapping criterion belongs.

10. The method of claim 9, further comprising:
for each of the failures or exceptions to the subgroup mapping criteria, displaying a strategy priority of the strategy to which that subgroup mapping criterion belongs.

11. The method of claim 8, further comprising:
for each of the failures or exceptions to the subgroup mapping criteria, displaying a number of stores to which the failure or exception is applicable.

12. The method of claim 8, further comprising:
for each of the failures or exceptions to the subgroup mapping criteria, displaying a list of the particular stores to which the failure or exception is applicable.

13. A computing system comprising:
one or more processors;
one or more computer-readable tangible storage devices;
a display device;
a user input device;
program instructions, stored on at least one of the one or more computer-readable tangible storage devices, to provide a user interface configured for presenting data on product subgroups for a product adjacency group and receiving user inputs associated with user-editable mapping criteria for mapping the product subgroups in the product adjacency group;
program instructions, stored on at least one of the one or more computer-readable tangible storage devices, to configure the user interface with indications of the product subgroups that are user-selectable for editing the user-editable mapping criteria of the product subgroups;
program instructions, stored on at least one of the one or more computer-readable tangible storage devices, to receive one or more user inputs indicating one or more user-selected product subgroups from among the product subgroups;
program instructions, stored on at least one of the one or more computer-readable tangible storage devices, to configure the user interface with user-selectable options for editing the user-editable mapping criteria of the product subgroups, and for assigning priority values to the user-editable mapping criteria;
program instructions, stored on at least one of the one or more computer-readable tangible storage devices, to receive one or more user inputs for each of the user-editable mapping criteria;
program instructions, stored on at least one of the one or more computer-readable tangible storage devices, to generate a combined set of mapping criteria for the one or more user-selected product subgroups based on the one or more user inputs for each of the user-editable mapping criteria and one or more non-user-editable mapping criteria stored in a mapping rules data store;
program instructions, stored on at least one of the one or more computer-readable tangible storage devices, to generate a product subgroup map for the one or more user-selected product subgroups based on the combined set of mapping criteria for the one or more user-selected product subgroups and a set of physical store layout data for at least one store;
program instructions, stored on at least one of the one or more computer-readable tangible storage devices, to provide a graphical output of the product subgroup map for the product adjacency group; and
program instructions, stored on at least one of the one or more computer-readable tangible storage devices, to generate a report for the product subgroup map for the product adjacency group.

14. The computing system of claim 13, further comprising:
program instructions, stored on at least one of the one or more computer-readable tangible storage devices, to combine information on the product subgroup map with information on previous product subgroup maps for the product adjacency group;
program instructions, stored on at least one of the one or more computer-readable tangible storage devices, to track a number of times a product subgroup map has been generated for the at least one store; and
program instructions, stored on at least one of the one or more computer-readable tangible storage devices, to configure the user interface to provide indications of the number of times a product subgroup map has been generated for the at least one store.

15. The computing system of claim 13, further comprising:
program instructions, stored on at least one of the one or more computer-readable tangible storage devices, to configure the user interface with user-selectable indications of a plurality of stores;
program instructions, stored on at least one of the one or more computer-readable tangible storage devices, to generate a plurality of product subgroup maps for the one or more user-selected product subgroups for each of the plurality of store layouts associated with each store of the plurality of the stores as selected by the user inputs, based on the combined set of mapping criteria for the one or more user-selected product subgroups and a set of physical store layout data for each store of the plurality of stores; and
program instructions, stored on at least one of the one or more computer-readable tangible storage devices, to provide a graphical output of the plurality of product subgroup maps for the product adjacency group for each of the plurality of store layouts.

16. The computing system of claim 13, further comprising:
program instructions, stored on at least one of the one or more computer-readable tangible storage devices, to display failures or exceptions to one or more of the subgroup mapping criteria;
program instructions, stored on at least one of the one or more computer-readable tangible storage devices, to display, for each of the failures or exceptions to the subgroup mapping criteria, a strategy to which that subgroup mapping criterion belongs;
program instructions, stored on at least one of the one or more computer-readable tangible storage devices, to display, for each of the failures or exceptions to the subgroup mapping criteria, a strategy priority of the strategy to which that subgroup mapping criterion belongs;
program instructions, stored on at least one of the one or more computer-readable tangible storage devices, to display, for each of the failures or exceptions to the subgroup mapping criteria, a number of stores to which the failure or exception is applicable; and
program instructions, stored on at least one of the one or more computer-readable tangible storage devices, to display, for each of the failures or exceptions to the subgroup mapping criteria, a list of the particular stores to which the failure or exception is applicable.

17. A computer program product comprising:
one or more computer-readable tangible storage devices;
program instructions, stored on at least one of the one or more computer-readable tangible storage devices, to provide a user interface configured for presenting data on product subgroups for a product adjacency group and receiving user inputs associated with user-editable mapping criteria for mapping the product subgroups in the product adjacency group;
program instructions, stored on at least one of the one or more computer-readable tangible storage devices, to configure the user interface with indications of the product subgroups that are user-selectable for editing the user-editable mapping criteria of the product subgroups;
program instructions, stored on at least one of the one or more computer-readable tangible storage devices, to receive one or more user inputs indicating one or more user-selected product subgroups from among the product subgroups;
program instructions, stored on at least one of the one or more computer-readable tangible storage devices, to configure the user interface with user-selectable options for editing the user-editable mapping criteria of the product subgroups, and for assigning priority values to the user-editable mapping criteria;
program instructions, stored on at least one of the one or more computer-readable tangible storage devices, to receive one or more user inputs for each of the user-editable mapping criteria;
program instructions, stored on at least one of the one or more computer-readable tangible storage devices, to generate a combined set of mapping criteria for the one or more user-selected product subgroups based on the one or more user inputs for each of the user-editable mapping criteria and one or more non-user-editable mapping criteria stored in a mapping rules data store;
program instructions, stored on at least one of the one or more computer-readable tangible storage devices, to generate a product subgroup map for the one or more user-selected product subgroups based on the combined set of mapping criteria for the one or more user-selected product subgroups and a set of physical store layout data for at least one store;
program instructions, stored on at least one of the one or more computer-readable tangible storage devices, to provide a graphical output of the product subgroup map for the product adjacency group; and
program instructions, stored on at least one of the one or more computer-readable tangible storage devices, to generate a report for the product subgroup map and previous product subgroup maps for the product adjacency group.

18. The computer program product of claim 17, further comprising:
program instructions, stored on at least one of the one or more computer-readable tangible storage devices, to combine information on the product subgroup map with information on previous product subgroup maps for the product adjacency group;
program instructions, stored on at least one of the one or more computer-readable tangible storage devices, to track a number of times a product subgroup map has been generated for the at least one store; and
program instructions, stored on at least one of the one or more computer-readable tangible storage devices, to configure the user interface to provide indications of the number of times a product subgroup map has been generated for the at least one store.

19. The computer program product of claim 17, further comprising:
program instructions, stored on at least one of the one or more computer-readable tangible storage devices, to configure the user interface with user-selectable indications of a plurality of stores;
program instructions, stored on at least one of the one or more computer-readable tangible storage devices, to generate a plurality of product subgroup maps for the one or more user-selected product subgroups for each of the plurality of store layouts associated with each store of the plurality of the stores as selected by the user inputs, based on the combined set of mapping criteria for the one or more user-selected product subgroups and a set of physical store layout data for each store of the plurality of stores; and
program instructions, stored on at least one of the one or more computer-readable tangible storage devices, to provide a graphical output of the plurality of product subgroup maps for the product adjacency group for each of the plurality of store layouts.

20. The computer program product of claim 17, further comprising:
program instructions, stored on at least one of the one or more computer-readable tangible storage devices, to display failures or exceptions to one or more of the subgroup mapping criteria;
program instructions, stored on at least one of the one or more computer-readable tangible storage devices, to display, for each of the failures or exceptions to the subgroup mapping criteria, a strategy to which that subgroup mapping criterion belongs;
program instructions, stored on at least one of the one or more computer-readable tangible storage devices, to display, for each of the failures or exceptions to the subgroup mapping criteria, a strategy priority of the strategy to which that subgroup mapping criterion belongs;
program instructions, stored on at least one of the one or more computer-readable tangible storage devices, to display, for each of the failures or exceptions to the subgroup mapping criteria, a number of stores to which the failure or exception is applicable; and
program instructions, stored on at least one of the one or more computer-readable tangible storage devices, to display, for each of the failures or exceptions to the subgroup mapping criteria, a list of the particular stores to which the failure or exception is applicable.
